(19) United States
(12) Patent Application Publication
(10) Pub. No.: US 2025/0266872 A1
(43) Pub. Date: Aug. 21, 2025

(54) UPLINK TRANSMIT PRECODING MATRIX UNDER MIXED FEEDBACK CONDITIONS: OPEN LOOP

(71) Applicant: Lenovo (United States) Inc., Morrisville, NC (US)

(72) Inventors: Vijay NANGIA, WOODRIDGE, IL (US); Ahmed HINDY, Aurora, IL (US)

(21) Appl. No.: 19/197,650

(22) Filed: May 2, 2025

(51) Int. Cl. H04B 7/0456; H04L 5/00; H04W 72/0453; H04W 72/21

(52) U.S. Cl. CPC H04B 7/0456; H04L 5/0048; H04W 72/0453; H04W 72/21

(57) ABSTRACT

Various aspects of the present disclosure relate to a User Equipment (UE) configured to or operable to receive a configuration signal indicating a precoding scheme for transmitting a sequence of data symbols over a set of antenna ports and a set of frequency resources for uplink (UL) transmissions, and transmit each symbol in the sequence of symbols from at least two antenna ports of the set of antenna ports, and at least two frequency resources of the set of frequency resources. Transmitting each symbol in the sequence of symbols includes transmitting a first symbol using a first port of the at least two antenna ports and a first frequency resource of the at least two frequency resources, and transmitting a transformed function of the first symbol using a second port of the at least two antenna ports and a second frequency resource of the at least two frequency resources.

### TECHNICAL FIELD

The present disclosure relates to wireless communications, and more specifically to uplink transmissions using a precoding scheme and associated signaling.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a configuration signal indicating a precoding scheme for transmitting a sequence of data symbols over a set of antenna ports and a set of frequency resources for uplink (UL) transmissions and transmit each symbol in the sequence of symbols from at least two antenna ports of the set of antenna ports, and at least two frequency resources of the set of frequency resources. Transmitting each symbol in the sequence of symbols may include transmitting a first symbol using a first port of the at least two antenna ports and a first frequency resource of the at least two frequency resources, and transmitting a transformed function of the first symbol using a second port of the at least two antenna ports and a second frequency resource of the at least two frequency resources.

In some implementations of the UE and the method described herein, the precoding scheme is an open-loop precoding scheme comprising a Space-Frequency Block Coding (SFBC) scheme.

In some implementations of the UE and the method described herein, the configuration signal indicates a set of Sounding Reference Signals (SRSs) associated with the UL transmissions.

In some implementations of the UE and the method described herein, the UE is configured to cause the UE to apply at least one of a modulation order and a channel code rate to the sequence of data symbols based on the set of SRSs.

In some implementations of the UE and the method described herein, the UE is further configured to cause the UE to select a comb structure of the set of SRSs based on a size of the set of antenna ports.

In some implementations of the UE and the method described herein, an index offset value associated with the comb structure of the set of SRS changes across time slots carrying the set of SRSs.

In some implementations of the UE and the method described herein, at least a portion of the sequence of symbols have complex values, and the transformed function of the first symbol is a conjugate transposition transformation.

In some implementations of the UE and the method described herein, transmitting each symbol in the sequence of symbols further includes transmitting a second symbol using the first port and the second frequency resource, and transmitting a transformed function of the second symbol using the second port and the first frequency resource, wherein the transformed function of the second symbol is the same transformed function as the transformed function of the first symbol except for a phase offset.

In some implementations of the UE and the method described herein, the sequence of symbols is transmitted over a Physical Uplink Control Channel (PUCCH) or a Physical Uplink Shared Channel (PUSCH), and the first symbol and the second symbol are associated with a same transmission layer.

In some implementations of the UE and the method described herein, the sequence of symbols is transmitted over the PUSCH, and the first symbol and the second symbol are associated with first transmission layer and a second transmission layer of an UL codeword transmission, respectively.

In some implementations of the UE and the method described herein, the at least two frequency resources correspond to at least two sub-carriers, at least two groups of sub-carriers, at least two Resource Blocks (RBs), or at least two groups of RBs.

In some implementations of the UE and the method described herein, a number of ports of a Demodulation Reference Signal (DMRS) associated with a PUSCH transmission from the UE is equal to a number of antenna ports in the at least two antenna ports, and wherein the DMRS from the at least two antenna ports are orthogonally multiplexed in at least one of time, frequency, and code domains.

In some implementations of the UE and the method described herein, each DMRS port of the DMRS ports is Quasi-Co-Located with a respective SRS port, and a mapping of the DMRS ports and SRS ports is based on identifier values of the DMRS ports, identifier values of the SRS ports, or both.

In some implementations of the UE and the method described herein, the quasi-colocation is with respect to average delay, delay spread, Doppler shift, Doppler spread, average gain, spatial parameter, or a combination thereof.

An NE (e.g., a base station) for wireless communication is described. The NE may be configured to, capable of, or operable to perform one or more operations as described herein. For example, the NE may be configured to, capable of, or operable to transmit a configuration signal indicating a precoding scheme for transmitting a sequence of data symbols over a set of antenna ports and a set of frequency resources for UL transmissions, and receive each symbol in the sequence of symbols from at least two antenna ports of the set of antenna ports, and at least two frequency resources of the set of frequency resources. Transmitting each symbol in the sequence of symbols may include receiving a first symbol using a first port of the at least two antenna ports and a first frequency resource of the at least two frequency resources, and receiving a transformed function of the first symbol using a second port of the at least two antenna ports and a second frequency resource of the at least two frequency resources.

### BRIEF DESCRIPTION OF THE DRAWINGS

FIG. 1 illustrates an example of a wireless communications system in accordance with aspects of the present disclosure.

FIG. 2 illustrates an example of a precoding matrix for single-layer transmission using two antenna ports in accordance with aspects of the present disclosure.

FIG. 3 illustrates an example of a precoding matrix for single-layer transmission using four antenna ports with transform precoding enabled in accordance with aspects of the present disclosure.

FIG. 4 illustrates an example of a precoding matrix for single-layer transmission using four antenna ports with transform precoding disabled in accordance with aspects of the present disclosure.

FIG. 5 illustrates an example of a precoding matrix for two-layer transmission using two antenna ports with transform precoding disabled in accordance with aspects of the present disclosure.

FIG. 6 illustrates an example of a precoding matrix for two-layer transmission using four antenna ports with transform precoding disabled in accordance with aspects of the present disclosure.

FIG. 7 illustrates an example of a precoding matrix for three-layer transmission using four antenna ports with transform precoding disabled in accordance with aspects of the present disclosure.

FIG. 8 illustrates an example of a precoding matrix for four-layer transmission using four antenna ports with transform precoding disabled in accordance with aspects of the present disclosure.

FIG. 9 illustrates an example of a mapping of 6 symbols over six frequency resources and four ports in accordance with aspects of the present disclosure.

FIG. 10 illustrates an example of a mapping of 6 symbols over six frequency resources and four ports in accordance with aspects of the present disclosure.

FIG. 11 illustrates an example of a mapping of over 6 frequency resources in accordance with aspects of the present disclosure.

FIG. 12 illustrates an example of a comb-2 structure in accordance with aspects of the present disclosure.

FIG. 13 illustrates an example of a comb-4 structure in accordance with aspects of the present disclosure.

FIG. 14 illustrates an example of a Bandwidth Part (BWP) comprising eight frequency resources in accordance with aspects of the present disclosure.

FIG. 15 illustrates an example of a BWP comprising eight frequency resources in accordance with aspects of the present disclosure.

FIG. 16 illustrates an example of a BWP comprising eight frequency resources in accordance with aspects of the present disclosure.

FIG. 17 illustrates an example of a UE in accordance with aspects of the present disclosure.

FIG. 18 illustrates an example of a processor in accordance with aspects of the present disclosure.

FIG. 19 illustrates an example of a NE in accordance with aspects of the present disclosure.

FIG. 20 illustrates a flowchart of method performed by a UE in accordance with aspects of the present disclosure.

FIG. 21 illustrates a flowchart of method performed by a NE in accordance with aspects of the present disclosure.

### DETAILED DESCRIPTION

In New Radio (NR), the resources allocated for feeding back the transmit precoding matrix indicator (TPMI) for uplink (UL) transmission is very limited. Conventional codebook-based TPMI signaling, in which the network selects a codebook from a set of pre-defined codebooks for UL transmission and each codebook is characterized by a transmission rank, an antenna coherence assumption and a specific selection of antenna ports per transmission layer. Non-codebook-based transmission is transparent in the sense that the UE transmits a specific group of beamformed Sounding Reference Signals (SRSs) using one or more SRS resources, and the network selects a subset of the SRS(s) within the group that corresponds to the best beam(s) and indicates them to the UE via an SRS resource indicator (SRI).

One solution is Configuring a UE with an UL TPMI that extends the Rel-15 legacy codebook-based TPMI via replicating a same codeword over two antenna groups. However, this approach only fits scenarios with partial coherence assumptions where two ports associated with the two antenna groups are non-coherent.

Another solution is configuring the UE with an UL TPMI that is based on a Discrete Fourier Transform (DFT) transformation, i.e., based on columns of a DFT matrix. However, this approach only fits scenarios with full coherence assumptions where all antenna ports are fully coherent.

Another solution is open-loop precoding with sub-band cyclic precoding. This approach uses different cyclic shifts across different frequency sub-bands. However, performance of open-loop with sub-band cyclic precoding is dominated by deep fades caused by the worst performing precoding vectors, leading to drop in average performance.

In general, the current UL precoding framework uses a very limited number of bits for precoder information at the expense of performance, compared with a downlink (DL) Channel State Information (CSI) framework in which the CSI fed back from the UE via Uplink Control Information (UCI) can be very large (>1000 bits at large bandwidth). However, CSI can provide significantly better performance.

The present disclosure describes a new UL TPMI framework that improves UL transmission throughput with reasonable signaling overhead.

Some embodiments relate to open-loop UL precoding based on Space-Frequency Block Decoding (SFBC) along with SRS and Demodulation Reference Signals (DMRS) for Physical Uplink Shared Channel (PUSCH) transmissions. SRSs are used for Modulation Coding Scheme (MCS) level determinations, DMRSs are used for per-antenna port channel estimation, while utilizing SFBC across different sub-carriers, which may improve coverage in high-speed scenarios or scenarios where closed-loop precoding is not feasible.

Some embodiments relate to closed-loop UL precoding with PMI-common signalling for multiple slots. For high-resolution TPMI, the precoding matrix is not expected to vary across slots, and hence a UE scheduled with PUSCH via multiple Downlink Control Information (DCI) signals, or by Configured-Grant (CG)-PUSCH may not require slot-specific TPMI. Instead, a UE may be configured with a common TPMI that is applicable for UL precoding within a configured time window for UL transmissions.

Some embodiments relate to closed-loop UL precoding with differential PMI signalling. In order to maintain DCI overhead balanced for sub-band based closed-loop TPMI reporting, differential reporting of the TPMI is supported by fragmenting the TPMI based on alternating sub-bands reported over different slots, where the first TPMI received over the first iteration, e.g., over odd sub-bands, can be utilized for the entire bandwidth by precoding extrapolation.

Several implementations and examples are provided to explain embodiments and clarify how they can be adopted in practical scenarios. These embodiments strike an efficient balance between the UL codebook performance and the corresponding TPMI signaling overhead for different antenna configurations and coherence assumptions at the UE side.

Aspects of the present disclosure are described in the context of a wireless communications system.

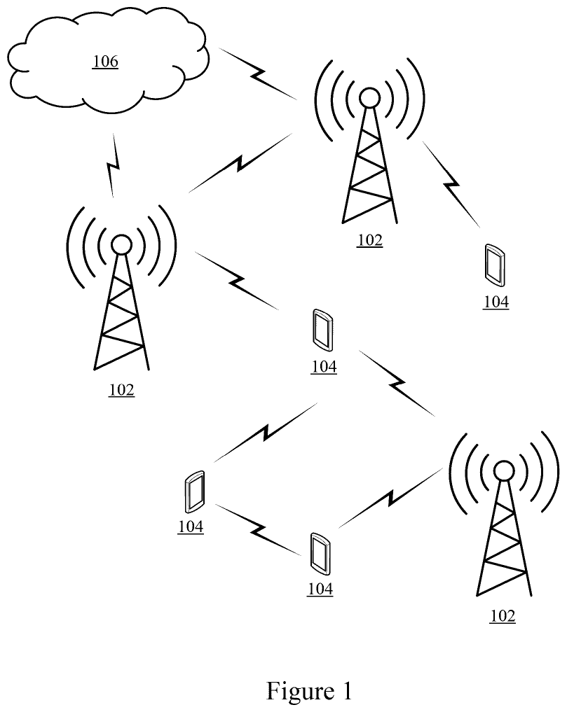

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=³) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

### Codebook Types

The following section describes aspects of codebooks that may be used for embodiments of the present disclosure. This description is only by way of example, and should not be construed as limiting.

A gNB may be equipped with a two-dimensional (2D) antenna array with N₁, N₂ antenna ports per polarization placed horizontally and vertically and communication occurs over N₃ PMI sub-bands. A PMI subband has a set of resource blocks, each resource block consisting of a set of subcarriers. In such case, 2N₁N₂ Channel State Information-Reference Signal (CSI-RS) ports are utilized to enable DL channel estimation with high resolution for NR Rel. 15 Type-II codebook. In order to reduce the UL feedback overhead, a Discrete Fourier transform (DFT)-based CSI compression of the spatial domain is applied to L dimensions per polarization, where L<N₁N₂. In the sequel the indices of the 2L dimensions are referred as the Spatial Domain (SD) basis indices. The magnitude and phase values of the linear combination coefficients for each sub-band are fed back to the gNB as part of the CSI report. The 2N₁N₂×N₃ codebook per layer takes on the form:

W=W₁\tilde{W}₂W_{f}^{H},

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${u}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W₂ are independent for different layers.

The following section describes aspects of NR Rel. 15 Type-II codebooks that may be used for embodiments of the present disclosure. This description is only by way of example, and should not be construed as limiting.

For 4 antenna ports {3000, 3001, . . . , 3003}, 8 antenna ports {3000, 3001, . . . 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII’.

The values of N₁ and N₂ are configured with the higher layer parameter n1-n2-codebookSubsetRestriction. The supported configurations of (N₁, N₂) for a given number of CSI-RS ports and the corresponding values of (O₁, O₂) are given in Table 5.2.2.2.1-2 of 3GPP TS 38.214. The number of CSI-RS ports, P_{CSI-RS}, is 2N₁N₂.

The value of L is configured with the higher layer parameter numberOfBeams, where L=2 when P_{CSI-RS}=4 and L∈{2,3,4} when P_{CSI-RS}>4. The value of N_{PSK} is configured with the higher layer parameter phaseAlphabetSize, where N_{PSK} ∈{4,8}. The UE is configured with the higher layer parameter subbandAmplitude set to ‘true’ or ‘false’. The UE may not report RI>2.

When v≤2, where v is the associated RI value, each PMI value corresponds to the codebook indices i₁ and i₂ where

$${i}_{1} = \{ \begin{matrix}[ \begin{matrix}\begin{matrix}\begin{matrix}{i}_{1 , 1} & {i}_{1 , 2}\end{matrix} & {i}_{1 , 3 , 1}\end{matrix} & {i}_{1 , 4 , 1}\end{matrix} ] \\ [ \begin{matrix}\begin{matrix}\begin{matrix}\begin{matrix}\begin{matrix}{i}_{1 , 1} & {i}_{1 , 2}\end{matrix} & {i}_{1 , 3 , 1}\end{matrix} & {i}_{1 , 4 , 1}\end{matrix} & {i}_{1 , 3 , 2}\end{matrix} & {i}_{1 , 4 , 2}\end{matrix} ]\end{matrix} \begin{matrix}υ = 1 \\ υ = 2\end{matrix}$$

$${i}_{12} = \{ \begin{matrix}[ {i}_{2 , 1 , 1} ] & subbandAmplitude = ' false ' , υ = 1 \\ [ \begin{matrix}{i}_{2 , 1 , 1} & {i}_{2 , 1 , 2}\end{matrix} ] & subbandAmplitude = ' false ' , υ = 2 \\ [ \begin{matrix}{i}_{2 , 1 , 1} & {i}_{2 , 2 , 1}\end{matrix} ] & subbandAmplitude = ' true ' , υ = 1 \\ [ \begin{matrix}\begin{matrix}\begin{matrix}{i}_{2 , 1 , 1} & {i}_{2 , 2 , 1}\end{matrix} & {i}_{2 , 1 , 2}\end{matrix} & {i}_{2 , 2 , 2}\end{matrix} ] & subbandAmplitude = ' true ' , υ = 2\end{matrix}$$

The L vectors combined by the codebook are identified by the indices i_{1,1} and i_{1,2}, where

$${i}_{1 , 1} = [ \begin{matrix}{q}_{1} & {q}_{2}\end{matrix} ]$$

$${q}_{1} ∈ \{ 0 , 1 , … , {O}_{1} - 1 \}$$

$${q}_{2} ∈ \{ 0 , 1 , … , {O}_{2} - 1 \}$$

$${i}_{1 , 2} ∈ \{ 0 , 1 , … , ( \begin{matrix}{N}_{1} {N}_{2} \\ L\end{matrix} ) - 1 \} .$$

$$Let$$

$${n}_{1} = [ {n}_{1}^{( 0 )} , … , {n}_{1}^{( L - 1 )} ]$$

$${n}_{2} = [ {n}_{2}^{( 0 )} , … , {n}_{2}^{( L - 1 )} ]$$

$${n}_{1}^{( i )} ∈ \{ 0 , 1 , … , {N}_{1} - 1 \}$$

$${n}_{2}^{( i )} ∈ \{ 0 , 1 , … , {N}_{2} - 1 \}$$

$$and$$

$$C ( x , y ) = \{ \begin{matrix}( \begin{matrix}x \\ y\end{matrix} ) & x \geq y \\ 0 & x < y\end{matrix} .$$

where the values of C(x,y) are given in Table 1.

Then the elements of n₁ and n₂ are found from i_{1,2} using the algorithm:

s₋₁ = 0
for i = 0, . . . . , L − 1
Find the largest x*∈{L − 1 − i, . . . , N₁N₂ − 1 − i} in Table 1 such that
i_{1,2} − sᵢ₋₁ ≥ C(x*, L − i)
eᵢ = C(x*, L − i)
sᵢ = sᵢ₋₁ + eᵢ
n⁽ⁱ⁾ = N₁N₂ − 1 − x*
n₁⁽ⁱ⁾ = n⁽ⁱ⁾ mod N₁
${n}_{2}^{( i )} = \frac{( {n}^{( i )} - {n}_{1}^{( i )} )}{{N}_{1}}$

When n₁ and n₂ are known, i_{1,2} is found using: n⁽ⁱ⁾=N₁n₂⁽ⁱ⁾+n₁⁽ⁱ⁾ (where the indices i=0, 1, . . . , L−1 are assigned such that n⁽ⁱ⁾ increases as i increases i_{1,2}=Σᵢ₌₀^{L-1}C(N₁N₂−1−n⁽ⁱ⁾,L−i), where C(x,y) is given in Table 1.
If N₂=1, q₂=0 and n₂⁽ⁱ⁾=0 for i=0, 1, . . . , L−1, and q₂ is not reported.
When (N₁, N₂)=(2,1), n₁=[0,1] and n₂=[0,0], and i_{1,2} is not reported.
When (N₁, N₂)=(4,1) and L=4, n₁=[0,1,2,3] and n₂=[0,0,0,0], and i_{1,2} is not reported.
When (N₁, N₂)=(2,2) and L=4, n₁=[0,1,0,1] and n₂=[0,0,1,1], and i_{1,2} is not reported.

TABLE 1

| | 1 | 2 | 3 | 4 |
|---|---|---|---|---|
| 0 | 0 | 0 | 0 | 0 |
| 1 | 1 | 0 | 0 | 0 |
| 2 | 2 | 1 | 0 | 0 |
| 3 | 3 | 3 | 1 | 0 |
| 4 | 4 | 6 | 4 | 1 |
| 5 | 5 | 10 | 10 | 5 |
| 6 | 6 | 15 | 20 | 15 |
| 7 | 7 | 21 | 35 | 35 |
| 8 | 8 | 28 | 56 | 70 |
| 9 | 9 | 36 | 84 | 126 |
| 10 | 10 | 45 | 120 | 210 |
| 11 | 11 | 55 | 165 | 330 |
| 12 | 12 | 66 | 220 | 495 |
| 13 | 13 | 78 | 286 | 715 |
| 14 | 14 | 91 | 364 | 1001 |
| 15 | 15 | 105 | 455 | 1365 |

The strongest coefficient on layer l=1, . . . , v is identified by i_{1,3,l}∈{0, 1, . . . , 2L−1}. The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ]$$

$${i}_{2 , 2 , l} = [ {k}_{l , 0}^{( 2 )} , {k}_{l , 1}^{( 2 )} , … , {k}_{l , 2 L - 1}^{( 2 )} ]$$

$${k}_{l , i}^{( 1 )} ∈ \{ 0 , 1 , … , 7 \}$$

$${k}_{l , i}^{( 2 )} ∈ \{ 0 , 1 \}$$

for l=1, . . . , v. The mapping from k_{l,i}⁽¹⁾ to the amplitude coefficient p_{l,i}⁽¹⁾ is given in Table 2 and the mapping from k_{l,i}⁽²⁾ to the amplitude coefficient p_{l,i}⁽²⁾ is given in Table 3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ]$$

$${p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

Mapping of elements of i_{1,4,l}: k_{l,i}⁽¹⁾ to p_{l,i}⁽¹⁾ are presented in the following Table 2:

| k_{l, i}⁽¹⁾ | p_{l, i}⁽¹⁾ |
|---|---|
| 0 | 0 |
| 1 | \sqrt{1/64} |
| 2 | \sqrt{1/32} |
| 3 | \sqrt{1/16} |
| 4 | \sqrt{⅛} |
| 5 | \sqrt{¼} |
| 6 | \sqrt{½} |
| 7 | 1 |

Mapping of elements of i_{2,2,l}: k_{l,i}⁽²⁾ to p_{l,i}⁽²⁾ are presented in the following Table 3:

| k_{l, i}⁽²⁾ | p_{l, i}⁽²⁾ |
|---|---|
| 0 | \sqrt{½} |
| 1 | 1 |

The phase coefficient indicators are

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows. The indicators k_{l,i}_{_{1,3,l}}⁽¹⁾=7, k_{l,i}_{_{1,3,l}}⁽²⁾=1, and c_{l,i}_{_{1,3,l}}⁽¹⁾=0 (l=1, . . . , v). k_{l,i}_{_{1,3,l}}⁽¹⁾, l_{l,i}_{_{1,3,l}}⁽²⁾, and c_{l,i}_{_{1,3,l}} are not reported for l=1, . . . , v. The remaining 2L−1 elements of i_{1,4,l} (l=1, . . . , v) are reported, where k_{l,i}⁽¹⁾∈{0, 1, . . . , 7}. Let Mₗ (l=1, . . . , v) be the number of elements of i_{1,4,l} that satisfy k_{l,i}⁽¹⁾>0.

The remaining 2L−1 elements of i_{2,1,l} and i_{2,2,l} (l=1, . . . , v) are reported as follows: When subbandAmplitude is set to ‘false’, −k_{l,i}⁽²⁾=1 for l=1, . . . , v, and i=0,1, . . . , 2L−1. i_{2,2,l} is not reported for l=1, . . . , v. For l=1, . . . , v, the elements of i_{2,1,l} corresponding to the coefficients that satisfy k_{l,i}⁽¹⁾>0, i≠i_{1,3,l} as determined by the reported elements of i_{1,4,l}, are reported, where c_{l,i}∈{0,1, . . . ,N_{PSK}−1} and the remaining 2L−Mₗ elements of i_{2,1,l} are not reported and are set to c_{l,i}=0.

When subbandAmplitude is set to ‘true’,—For l=1, . . . , v, the elements of i_{2,2,l} and i_{2,1,l} corresponding to the min(Mₗ, K⁽²⁾)−1 strongest coefficients (excluding the strongest coefficient indicated by i_{1,3,l}), as determined by the corresponding reported elements of i_{1,4,l}, are reported, where k_{l,i}⁽²⁾∈{0,1} and c_{l,i}∈{0,1, . . . ,N_{PSK}−1}. The values of K⁽²⁾ are given in Table 4. The remaining 2L−min(Mₗ, K⁽²⁾) elements of i_{2,2,l} are not reported and are set to k_{l,i}⁽²⁾=1. The elements of i_{2,1,l} corresponding to the M₁−min(Mₗ, K⁽²⁾) weakest non-zero coefficients are reported, where c_{l,i}∈{0,1,2,3}. The remaining 2L−M₁ elements of i_{2,1,l} are not reported and are set to cₗ, i=0.

When two elements, k_{l,x}⁽¹⁾ and k_{l,y}⁽¹⁾, of the reported elements of i_{1,4,l} are identical (k=k_{l,x}⁽¹⁾=k_{l,y}⁽¹⁾), then element min(x,y) is prioritized to be included in the set of the min(M₁, K⁽²⁾)−1 strongest coefficients for i_{2,1,l} and i_{2,2,l} (l=1, . . . , v) reporting.

Full resolution subband coefficients when subbandAmplitude is set to ‘true’ are in the following Table 4:

| L | K⁽²⁾ |
|---|---|
| 2 | 4 |
| 3 | 4 |
| 4 | 6 |

The codebooks for 1-2 layers are given below, where the indices m₁⁽ⁱ⁾ and m₂⁽ⁱ⁾ are given by

$${m}_{1}^{( i )} = {O}_{1} {n}_{1}^{( i )} + {q}_{1}$$

$${m}_{2}^{( i )} = {O}_{2} {n}_{2}^{( i )} + {q}_{2}$$

The codebook for 1-layer and 2-layer CSI reporting using antenna ports 3000 to 2999+P_{CSI-RS} are reported in Table 5.2.2.2.4-1 of 3GPP TS 38.214.

When the UE is configured with higher layer parameter codebookType set to ‘typeII’, the bitmap parameter typeII-RI-Restriction forms the bit sequence r₁, r₀ where r₀ is the LSB and r₁ is the MSB. When rᵢ is zero, i∈{0,1}, PMI and RI reporting are not allowed to correspond to any precoder associated with v=i+1 layers. The bitmap parameter n1-n2-codebookSubsetRestriction forms the bit sequence B=B₁B₂ where bit sequences B₁, and B₂ are concatenated to form B. To define B₁ and B₂, first define the O₁O₂ vector groups G(r₁,r₂) as

$$G ( {r}_{1} , {r}_{2} ) = \{ {v}_{{N}_{1} {r}_{1} + {x}_{1} , {N}_{2} {r}_{2} + {x}_{2}} : {x}_{1} = 0 , 1 , … , {N}_{1} - 1 ; {x}_{2} = 0 , 1 , … , {N}_{2} - 1 \}$$

$$for$$

$${r}_{1} ∈ \{ 0 , 1 , … , {O}_{1} - 1 \}$$

$${r}_{2} ∈ \{ 0 , 1 , … , {O}_{2} - 1 \} .$$

The UE may be configured with restrictions for 4 vector groups indicated by (r₁^{(k)},r₂^{(k)}) for k=0,1,2,3 and identified by the group indices

$${g}^{( k )} = {O}_{1} {r}_{2}^{( k )} + {r}_{1}^{( k )}$$

For k=0,1, . . . , 3, where the indices are assigned such that g^{(k)} increases as k increases. The remaining vector groups are not restricted.

If N₂=1, g^{(k)}=k for k=0,1, . . . , 3, and B₁ is empty. If N₂>1, B₁=b₁⁽¹⁰⁾ . . . b₁⁽⁰⁾ is the binary representation of the integer β₁ where b₁⁽¹⁰⁾ is the MSB and b₁⁽⁰⁾ is the LSB. β₁ is found using:

$${β}_{1} = {Σ}_{k = 0}^{3} C ( {O}_{1} {O}_{2} - 1 - {g}^{( k )} , 4 - k ) ,$$

where C(x,y) is defined in Table 1. The group indices g(k) and indicators (r₁^{(k)},r₂^{(k)}) for k=0,1,2,3 may be found from β₁ using the algorithm:

s₋₁ = 0
for k = 0, . . . , 3
Find the largest x* ∈ {3 − k, . . . , O₁O₂ − 1 − k} such that β₁ − Sₖ₋₁ ≥
C(x*, 4 − k)
eₖ = C(x*, 4 − k)
sₖ = sₖ₋₁ + eₖ
g^{(k)} = O₁O₂ − 1 − x*
r₁^{(k)} = g^{(k)} mod O₁
${r}_{2}^{( k )} = \frac{( {g}^{( k )} - {r}_{1}^{( k )} )}{{o}_{1}}$

The bit sequence B₂=B₂⁽⁰⁾B₂⁽¹⁾B₂⁽²⁾B₂⁽³⁾ is the concatenation of the bit sequences B₂^{(k)} for k=0, 1, . . . , 3, corresponding to the group indices g^{(k)}. The bit sequence B₂^{(k)} is defined as

$${B}_{2}^{( k )} = {b}_{2}^{( k , 2 {N}_{1} {N}_{2} - 1 )} … {b}_{2}^{( k , 0 )}$$

Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed amplitude coefficient p_{l,i}⁽¹⁾ for the vector in group g^{(k)} indexed by x₁,x₂, where the maximum amplitude coefficients are given in Table 5.2.2.2.3-6 of 3GPP TS 38.214. A UE that does not report parameter amplitudeSubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

The following section describes aspects of NR Rel. 15 Type-II Port Selection codebook that may be used for embodiments of the present disclosure. This description is only by way of example, and should not be construed as limiting.

For Type-II Port Selection codebook, only K (where K≤2N₁N₂) beamformed CSI-RS ports are utilized in DL transmission, in order to reduce complexity. The. The K×N₃ codebook matrix per layer takes on the form W=W₁^{PS}W₂.

Here, W₂ follow the same structure as the conventional NR Rel. 15 Type-II Codebook, and are layer specific. W₁^{PS} is a K×2L block-diagonal matrix with two identical diagonal blocks, i.e.,

$${W}_{1}^{P S} = [ \begin{matrix}E & 0 \\ 0 & E\end{matrix} ] ,$$

### and E is an

$$\frac{K}{2} \times L$$

matrix whose columns are standard unit vectors, as follows.

$$E = [ {e}_{m od ( {m}_{PS} {d}_{PS} , K / 2 )}^{( K / 2 )} \begin{matrix}{e}_{m od ( {m}_{PS} {d}_{PS} + 1 , K / 2 )}^{( K / 2 )} & … & {e}_{m od ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

Possible realizations of E are reported in part 2.1.2 of 3GPP TS 38.214.

For 4 antenna ports {3000, 3001, . . . , 3003}, 8 antenna ports {3000, 3001, . . . 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection’.

The number of CSI-RS ports is given by P_{CSI-RS} ∈{4,8,12,16,24,32} as configured by higher layer parameter nrofPorts. The value of L is configured with the higher layer parameter numberOfBeams, where L=2 when P_{CSI-RS}=4 and LE{2,3,4} when P_{CSI-RS}>4. The value of d is configured with the higher layer parameter portSelectionSamplingSize, where d∈{1,2,3,4} and

$$d \leq min ( \frac{{P}_{CSI - RS}}{2} , L ) .$$

The value of N_{PSK} is configured with the higher layer parameter phaseAlphabetSize, where N_{PSK}∈{4,8}. The UE is configured with the higher layer parameter subbandAmplitude set to ‘true’ or ‘false’. The UE may not report RI>2.

The UE is also configured with the higher layer parameter typeII-PortSelectionRI-Restriction. The bitmap parameter typeII-PortSelectionRI-Restriction forms the bit sequence r₁,r₀ where r₀ is the LSB and r₁ is the MSB. When rᵢ is zero, i∈{0,1}, PMI and RI reporting are not allowed to correspond to any precoder associated with v=i+1 layers.

When v≤2, where v is the associated RI value, each PMI value corresponds to the codebook indices i₁ and i₂ where

$${i}_{1} = \{ \begin{matrix}[ \begin{matrix}{i}_{1 , 1} & {i}_{1 , 3 , 1} & {i}_{1 , 4 , 1}\end{matrix} ] & v = 1 \\ [ \begin{matrix}{i}_{1 , 1} & {i}_{1 , 3 , 1} & {i}_{1 , 4 , 1} & {i}_{1 , 3 , 2} & {i}_{1 , 4 , 2}\end{matrix} ] & v = 2\end{matrix} \\ {i}_{2} = \{ \begin{matrix}[ {i}_{2 , 1 , 1} ] & subbandAmplitude = ' false ' , υ = 1 \\ [ \begin{matrix}{i}_{2 , 1 , 1} & {i}_{2 , 1 , 2}\end{matrix} ] & subbandAmplitude = ' false ' , υ = 2 \\ [ \begin{matrix}{i}_{2 , 1 , 1} & {i}_{2 , 2 , 1}\end{matrix} ] & subbandAmplitude = ' true ' , υ = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ' true ' , υ = 2\end{matrix} .$$

The L antenna ports per polarization are selected by the index i_{1,1}, where

$${i}_{1 , 1} ∈ \{ 0 , 1 , … , ⌈ \frac{{P}_{CSI - RS}}{2 d} ⌉ - 1 \} .$$

The strongest coefficient on layer l, l=1, . . . , v is identified by i_{1,3,l}∈{0,1, . . . , 2L−1}.

The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ] \\ {i}_{2 , 2 , l} = [ {k}_{l , 0}^{( 2 )} , {k}_{l , 1}^{( 2 )} , … , {k}_{l , 2 L - 1}^{( 2 )} ] \\ {k}_{l , i}^{( 1 )} ∈ \{ 0 , 1 , … , 7 \} \\ {k}_{l , i}^{( 2 )} ∈ \{ 0 , 1 \}$$

for l=1, . . . , v. The mapping from k_{l,i}⁽¹⁾ to the amplitude coefficient p_{l,i}⁽¹⁾ is given in Table 5.2.2.2.3-2 and the mapping from k_{l,i}⁽²⁾ to the amplitude coefficient p_{l,i}⁽²⁾ is given in Table 5.2.2.2.3-3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ] \\ {p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

The phase coefficient indicators are i_{2,1,l}=[c_{l,0}, c_{l,1}, . . . , c_{l,2L-1}] for l=1, . . . , v. The amplitude and phase coefficient indicators are reported as follows: The indicators k_{l,i}_{_{1,3,l}}⁽¹⁾=7, k_{l,i}_{_{1,3,l}}⁽²⁾=1, and c_{l,i}_{_{1,3,l}}=0^{(l=1, . . . , ν)}. k_{l,i}_{_{1,3,l}}⁽¹⁾, k_{l,i}_{_{1,3,l}}⁽²⁾, and c_{l,i}_{_{1,3,l}} are not reported for l=1, . . . , v.

The remaining 2L−1 elements of i_{1,4,l} (l=1, . . . , v) are reported, where k_{l,i}⁽¹⁾∈{0, 1, . . . , 7}. Let Mₗ (l=1, . . . , v) be the number of elements of i_{1,4,l} that satisfy k_{l,i}⁽¹⁾>0.

The remaining 2L−1 elements of i_{2,1,l} and i_{2,2,l} (l=1, . . . , v) are reported as follows: When subbandAmplitude is set to ‘false’, k_{l,i}⁽²⁾=1 for l=1, . . . , ν, and i=0,1, . . . , 2L−1. i_{2,2,l} is not reported for l=1, . . . , v. For l=1, . . . , v, the Mₗ−1 elements of i_{2,1,l} corresponding to the coefficients that satisfy k_{l,i}⁽¹⁾>0, i≠i_{1,3,l}, as determined by the reported elements of i_{1,4,l}, are reported, where c_{l,i}∈{0,1, . . . ,N_{PSK}−1} and the remaining 2L−Mₗ elements of i_{2,1,l} are not reported and are set to c_{l,i}=0.

When subbandAmplitude is set to ‘true’, For l=1, . . . , v, the elements of i_{2,2,l} and i_{2,1,l} corresponding to the min(Mₗ,K⁽²⁾)−1 strongest coefficients (excluding the strongest coefficient indicated by i_{1,3,l}), as determined by the corresponding reported elements of i_{1,4,l}, are reported, where k_{l,i}⁽²⁾∈{0,1} and c_{l,i}∈{0,1, . . . ,N_{PSK}−1}. The values of K⁽²⁾ are given in Table 5.2.2.2.3-4. The remaining 2L−min(Mₗ,K⁽²⁾) elements of i_{2,2,l} are not reported and are set to k_{l,i}⁽²⁾=1. The elements of i_{2,1,l} corresponding to the Mₗ−min(Mₗ,K⁽²⁾) weakest non-zero coefficients are reported, where c_{l,i}∈{0,1,2,3}. The remaining 2L−Mₗ elements of i_{2,1,l} are not reported and are set to c_{l,i}=0.

When two elements, k_{l,x}⁽¹⁾ and k_{l,y}⁽¹⁾, of the reported elements of i_{1,4,l} are identical (k_{l,x}⁽¹⁾=k_{l,y}⁽¹⁾), then element min(x,y) is prioritized to be included in the set of the min(Mₗ,K⁽²⁾)−1 strongest coefficients for i_{2,1,l} and i_{2,2,l} (l=1, . . . , v) reporting.

The codebooks for 1-2 layers are in Table 5.2.2.2.4-1 of 3GPP TS 38.214, and the quantity of φ_{l,i} is reported in 3GPP TS 38.214.

NR Rel. 15 Type-I codebook is the baseline codebook for NR, with a variety of configurations. The most common utility of Rel. 15 Type-I codebook is a special case of NR Rel. 15 Type-II codebook with L=1 for RI=1,2, wherein a phase coupling value is reported for each sub-band, i.e., W2 is 2×N3, with the first row equal to [1, 1, . . . , 1] and the second row equal to [e\hat{ }(j2πØ_0), . . . , e\hat{ }(j2πØ_(N3−1))]. Under specific configurations, ϕ0=ϕ1 . . . =ϕ, i.e., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only. More details on NR Rel. 15 Type-I codebook can be found in R1-1709232, Samsung et al., “WF on Type I and II CSI codebooks,” Hangzhou, China, May 15-19, 2017.

The following section describes aspects of NR Rel. 16 Type-II codebooks that may be used for embodiments of the present disclosure. This description is only by way of example, and should not be construed as limiting.

Assume the gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report.

The 2N₁N₂×N₃ codebook per layer takes on the form

W═W₁\tilde{W}₂W_{f}^{H},

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} - 1 , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$${W}_{f} = [ \begin{matrix}{f}_{{k}_{0}} & {f}_{{k}_{1}} & … & {f}_{{k}_{{M}^{′} - 1}}\end{matrix} ] , 0 \leq {k}_{i} < {N}_{3} - 1 , \\ {f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T} .\end{matrix}$$

Only the indices of the L selected columns of B are reported, along with the oversampling index taking on O₁O₂ values. Similarly for WF, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported.

Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

For 4 antenna ports {3000, 3001, . . . , 3003}, 8 antenna ports {3000, 3001, . . . 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’.

The values of N₁ and N₂ are configured with the higher layer parameter n1-n2-codebookSubsetRestriction-r16. The supported configurations of (N₁, N₂) for a given number of CSI-RS ports and the corresponding values of (O₁, O₂) are given in Table 5.2.2.2.1-2. The number of CSI-RS ports, P_{CSI-RS}, is 2N₁N₂.

The values of L, β and p_{ν} are determined by the higher layer parameter paramCombination-r16, where the mapping is given in Table 5.

The UE is not expected to be configured with paramCombination-r16 equal to 3, 4, 5, 6, 7, or 8 when P_{CSI-RS}=4, 7 or 8 when P_{CSI-RS}<32, 7 or 8 when higher layer parameter typeII-RI-Restriction-r16 is configured with rᵢ=1 for any i>1.7 or 8 when R=2. The parameter R is configured with the higher-layer parameter numberOfPMISubbandsPerCQISubband-r16. This parameter controls the total number of precoding matrices N₃ indicated by the PMI as a function of the number of configured subbands in csi-ReportingBand, the subband size configured by the higher-level parameter subbandSize and of the total number of PRBs in the bandwidth part according to Table 5.2.1.4-2 of 3GPP TS 38.214, as follows:

When R=1: One precoding matrix is indicated by the PMI for each subband in csi-ReportingBand.

When R=2: For each subband in csi-ReportingBand that is not the first or last subband of a BWP, two precoding matrices are indicated by the PMI: the first precoding matrix corresponds to the first N_{PRB}^{SB}/2 PRBs of the subband and the second precoding matrix corresponds to the last N_{PRB}^{SB}/2 PRBs of the subband.

For each subband in csi-ReportingBand that is the first or last subband of a BWP, If

$$( {N}_{BWP , i}^{start} mod {N}_{PRB}^{SB} ) \geq \frac{{N}_{PRB}^{SB}}{2} ,$$

one precoding matrix is indicated by the PMI corresponding to the first subband. If

$$( {N}_{BWP , i}^{start} mod {N}_{PRB}^{SB} ) < \frac{{N}_{PRB}^{SB}}{2} ,$$

two recoding matrices are indicated by the PMI corresponding to the first subband: the first precoding matrix corresponds to the first

$$\frac{{N}_{PRB}^{SB}}{2} - ( {N}_{BWP , i}^{start} mod {N}_{PRB}^{SB} )$$

PRBs of the first subband and the second precoding matrix corresponds to the last

$$\frac{{N}_{PRB}^{SB}}{2}$$

PRBs of the first subband. If 1+

$$( {N}_{BWP , i}^{start} + {N}_{BWP , i}^{size} - 1 ) mod {N}_{PRB}^{SB} \leq \frac{{N}_{PRB}^{SB}}{2} ,$$

one precoding matrix is indicated by the PMI corresponding to the last subband. If

$$1 + ( {N}_{BWP , i}^{start} + {N}_{BWP , i}^{size} - 1 ) mod {N}_{PRB}^{SB} > \frac{{N}_{PRB}^{SB}}{2} ,$$

two precoding matrices are indicated by the PMI corresponding to the last subband: the first precoding matrix corresponds to the first

$$\frac{{N}_{PRB}^{SB}}{2}$$

PRBs of the last subband and the second precoding matrix corresponds to the last

$$1 + ( {N}_{BWP , i}^{start} + {N}_{BWP , i}^{size} - 1 ) mod {N}_{PRB}^{SB} - \frac{{N}_{PRB}^{SB}}{2}$$

PRBs of the last subband.

TABLE 5
Codebook parameter configurations for L, β and p_{υ}

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE may report the RI value ν according to the configured higher layer parameter typeII-RI-Restriction-r16. The UE may not report ν>4. The PMI value corresponds to the codebook indices of iₗ and i₁, values of which are reported in 3GPP TS 38.214. The precoding matrices indicated by the PMI are determined from L+M_{ν} vectors. L vectors, σₘ_{₁}_{⁽ⁱ⁾}_{, m}_{₂}_{⁽ⁱ⁾}, i=0,1, . . . , L−1, are identified by the indices q₁, q₂, n₁, n₂, indicated by i_{1,1}, i_{1,2}, obtained as in 5.2.2.2.3 of 3GPP TS 38.214, where the values of C(x, y) are given in Table 4 above.

$${M}_{υ} = ⌈ {p}_{υ} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{υ} - 1 ,$$

are identified by Mᵢₙᵢₜᵢₐₗ (for N₃>19) and n_{3,l} (l=1, . . . , ν) where

$${M}_{initial} ∈ \{ - 2 {M}_{υ} + 1 , - 2 {M}_{υ} + 2 , … , 0 \} \\ {n}_{3 , l} = [ {n}_{3 , l}^{( 0 )} , … , {n}_{3 , l}^{( {M}_{υ} - 1 )} ] \\ {n}_{3 , l}^{( f )} ∈ \{ 0 , 1 , … , {N}_{3} - 1 \}$$

which are indicated by means of the indices i_{1,5} (for N₃>19) and i_{1,6,l} (for M_{ν}>1 and l=1, . . . , ν), where

$${i}_{1 , 5} ∈ \{ 0 , 1 , … , 2 {M}_{υ} - 1 \} \\ {i}_{1 , 6 , l} ∈ \{ \begin{matrix}\{ 0 , 1 , … , ( \begin{matrix}{N}_{3} - 1 \\ {M}_{υ} - 1\end{matrix} ) - 1 \} & {N}_{3} \leq 19 \\ \{ 0 , 1 , … , ( \begin{matrix}2 {M}_{υ} - 1 \\ {M}_{υ} - 1\end{matrix} ) - 1 \} & {N}_{3} > 19\end{matrix}$$

The amplitude coefficient indicators i_{2,3,l} and i_{2,4,l} are

$${i}_{2 , 3 , l} = [ {k}_{l , 0}^{( 1 )} {k}_{l , 1}^{( 1 )} ]$$

$${i}_{2 , 4 , l} = [ {k}_{l , 0}^{( 2 )} … {k}_{l , {M}_{υ} - 1}^{( 2 )} ]$$

$${k}_{l , f}^{( 2 )} = [ {k}_{l , 0 , f}^{( 2 )} … {k}_{l , 2 L - 1 , f}^{( 2 )} ]$$

k_{l,p}∈{1, . . . , 15}
k_{l,i,f}⁽²⁾∈{0, . . . , 7}
for l=1, . . . , ν.

The phase coefficient indicator i_{2,5,l} is

$${i}_{2 , 5 , l} = [ {c}_{l , 0} … {c}_{l , {M}_{υ} - 1} ] \\ {c}_{l , f} = [ {c}_{l , 0 , f} … {c}_{l , 2 L - 1 , f} ]$$

c_{l,i,f}∈{0, . . . ,15}
for l=1, . . . , ν.

Let K₀=[β2LM₁]. The bitmap whose nonzero bits identify which coefficients in i_{2,4,l} and i_{2,5,l} are reported, is indicated by i_{1,7,l}

$${i}_{1 , 7 , l} = [ {k}_{l , 0}^{( 3 )} … {k}_{l , {M}_{υ} - 1}^{( 3 )} ] \\ {k}_{l , f}^{( 3 )} = [ {k}_{l , 0 , f}^{( 3 )} … {k}_{l , 2 L - 1 , f}^{( 3 )} ] \\ {k}_{l , i , f}^{( 3 )} ∈ \{ 0 , 1 \}$$

for l=1, . . . , ν, such that Kₗ^{NZ}=Σᵢ₌₀^{2L-1} Σ_{f=0}^{M}^{_{ν}}⁻¹ k_{l,i,f}⁽³⁾≤K₀ is the number of nonzero coefficients for layer l=1, . . . , ν and K^{NZ}−Σₗ₌₁^{ν} Kₗ^{NZ}≤2K₀ is the total number of nonzero coefficients.

The indices of i_{2,4,l}, i_{2,5,l} and i_{1,7,l} are associated to the M_{ν} codebook indices in n_{3,l}. The mapping from k_{l,p}⁽¹⁾ to the amplitude coefficient p_{l,p}⁽¹⁾ is given in Table 6 and the mapping from k_{l,i,f}⁽²⁾ to the amplitude coefficient p_{l,i,f}⁽²⁾ is given in Table 7. The amplitude coefficients are represented by

$${p}_{l}^{( 1 )} = [ \begin{matrix}{p}_{l , 0}^{( 1 )} & {p}_{l , 1}^{( 1 )} ]\end{matrix} \\ {p}_{l}^{( 2 )} = [ {p}_{l , 0}^{( 2 )} … {p}_{l , {M}_{υ} - 1}^{( 2 )} ] \\ {p}_{l , f}^{( 2 )} = [ {p}_{l , 0 , f}^{( 2 )} … {p}_{l , 2 L - 1 , f}^{( 2 )} ]$$

for l=1, . . . , v.

Let fₗ*∈{0,1, . . . , M_{ν}−1} be the index of i_{2,4,l} and iₗ*∈{0,1, . . . , 2L−1} be the index of k_{l,f}_{ₗ}_{*} which identify the strongest coefficient of layer l, i.e., the element k_{l,i}_{ₗ}_{*,f}_{ₗ}_{*}⁽²⁾ of i_{2,4,l}, for l=1, . . . , ν. The codebook indices of n_{3,l} are remapped with respect to n_{3,l}^{(f}^{ₗ}^{*)} as n_{3,l}^{(f)}=(n_{3,l}^{(f)}−n_{3,l}^{(f}^{ₗ}^{*)})mod N₃, such that n_{3,l}^{(f}^{ₗ}^{*)}=0, after remapping. The index f is remapped with respect to fₗ* as f=(f−fₗ*)mod Mᵥ, such that the index of the strongest coefficient is fₗ*=0 (l=1, . . . , ν), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}∈{0,1, . . . , 2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix}$$

for l=1, . . . , ν.

TABLE 6
Mapping of elements of i_{2,3,l}: k_{l,p}⁽¹⁾ to p_{l,p}⁽¹⁾

| k_{l,p}⁽¹⁾ | p_{l,p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ( l = 1 , … , υ ) .$$

The indicators

$${k}_{l , ⌊ \frac{{i}_{l}^{*}}{L} ⌋}^{( 1 )} , {k}_{l , {i}_{l}^{*} , 0}^{( 2 )}$$

and c_{l,i*}_{ₗ}_{,0} are not reported for l=1, . . . , ν.

The indicator

$${k}_{l , ( ⌊ \frac{{i}_{l}^{*}}{L} ⌋ + 1 ) m od 2}^{( 1 )}$$

is reported for l=1, . . . , ν.

The K^{NZ}−ν indicators k_{l,i,f}⁽²⁾ for which k_{l,i,f}⁽³⁾=1, i≠iₗ**, f≠0 are reported.

The K^{NZ}−ν indicators c_{l,i,f} for which k_{l,i,f}⁽³⁾=1, i≠iₗ*, f≠0 are reported.

The remaining 2L·M_{ν}·ν_{-K}^{NZ} indicators k_{l,i,f}⁽²⁾ are not reported.

The remaining 2L·M_{ν}·ν−K^{NZ} indicators c_{l,i,f} are not reported.

TABLE 7
Mapping of elements of i_{2,4,l}: k_{l,i,f}⁽²⁾ to p_{l,,i,f}⁽²⁾

| k_{l,i,f}⁽²⁾ | p_{l,,i,f}⁽²⁾ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm described in 5.2.2.2.3 of 3GPP TS 38.214, where the values of C(x, y) are given in Table 8.

For N₃>19, Mᵢₙᵢₜᵢₐₗ is identified by i_{1,5}. For all values of N₃, n_{3,l}⁽⁰⁾=0 for l=1, . . . , ν. If M_{ν}>1, the nonzero elements of n_{3,l}, identified by n_{3,l}⁽¹⁾, . . . , n_{3,l}^{(M}^{_{ν}}⁻¹⁾, are found from i_{1,6,l} (l=1, . . . , ν), for N₃≤19, and from i_{1,6,l} (l=1, . . . , ν) and Mᵢₙᵢₜᵢₐₗ, for N₃>19, using C(x, y) as defined in Table 8 and the algorithm:

s₀ = 0
for f = 1, ... , Mᵥ − 1
Find the largest x* ∈ {Mᵥ − 1 − f, ... , N₃ − 1 − f} in Table 8 such
that
i_{1,6,l} − s_{f-1} ≥ C(x*, Mᵥ − f)
e_{f} = C(x*, Mᵥ − f)
s_{f} = s_{f-1} + e_{f}
if N₃ ≤ 19
n_{3,l}^{(f)} = N₃ − 1 − x*
else
nₗ^{(f)} = 2Mᵥ − 1 − x*
if nₗ^{(f)} ≤ Mᵢₙᵢₜᵢₐₗ + 2Mᵥ − 1
n_{3,l}^{(f)} = nₗ^{(f)}
else
n_{3,l}^{(f)} = nₗ^{(f)} + (N₃ − 2Mᵥ)
end if
end if

TABLE 8
Combinatorial coefficients C(x, y)

| | 1 | 2 | 3 | 4 | 5 | 6 | 7 | 8 | 9 |
|---|---|---|---|---|---|---|---|---|---|
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

When n_{3,l} and Mᵢₙᵢₜᵢₐₗ are known, i_{1,5} and i_{1,6,l} (l=1, . . . , ν) are found as follows: If N₃≤19, i_{1,5}=0 and is not reported. If M_{ν}=1, i_{1,6,l}=0, for l=1, . . . , ν, and is not reported. If M_{ν}>1, i_{1,6,l}=Σ₌₁^{M}^{_{ν}}⁻¹C (N₃−1−n_{3,l}^{(f)}, M_{ν}−f), where C(x, y) is given in Table 5.2.2.2.5-4 and where the indices f=1, . . . , M_{ν}−1 are assigned such that n_{3,l}^{(f)} increases as f increases. If N₃>19, Mᵢₙᵢₜᵢₐₗ is indicated by i_{1,5}, which is reported and given by

$${i}_{1 , 5} = \{ \begin{matrix}{M}_{initial} & {M}_{initial} = 0 \\ {M}_{initial} + 2 {M}_{υ} & {M}_{initial} < 0\end{matrix}$$

Only the nonzero indices n_{3,l}^{(f)}∈IntS, where IntS={(Mᵢₙᵢₜᵢₐₗ+i) mod N₃, i=0,1, . . . , 2M_{ν}−1}, are reported, where the indices f=1, . . . , M_{ν}−1 are assigned such that n_{3,l}^{(f)} increases as f increases. Let

$${n}_{l}^{( f )} = \{ \begin{matrix}{n}_{3 , l}^{( f )} & {n}_{3 , l}^{( f )} \leq {M}_{\text{initial}} + 2 {M}_{υ} − 1 \\ {n}_{3 , l}^{( f )} − ( {N}_{3} − 2 {M}_{υ} ) & {n}_{3 , l}^{( f )} > {M}_{\text{initial}} + {N}_{3} − 1\end{matrix} ,$$

then i_{1,6,l}=Σ_{f=1}^{M}^{_{ν}}⁻¹C (2M₈₄−1−nₗ^{(f)}, M_{ν}−f), where C(x, y) is given in Table 8.

The codebooks for 1-4 layers are given in Table 5.2.2.2.5-5 of 3GPP TS 38.214, where m₁⁽ⁱ⁾, m₂⁽ⁱ⁾, for i=0,1, . . . , L−1, νₘ_{₁}_{⁽ⁱ⁾}_{,m}_{₂}_{⁽ⁱ⁾} are obtained as in clause 5.2.2.2.3 of 3GPP TS 38.214, and the quantities φ_{l,i,f} and y_{t,l} are given by

$${φ}_{l , i , f} = {e}^{j \frac{2 π {c}_{l , i , f}}{16}}$$

$${y}_{t , l} = [ {y}_{t , l}^{( 0 )} {y}_{t , l}^{( 1 )} … {y}_{t , l}^{( {M}_{υ} - 1 )} ]$$

where t={0,1, . . . , N₃−1}, is the index associated with the precoding matrix, l={1, . . . , ν}, and with

$${y}_{t , l}^{( f )} = {e}^{j \frac{2 π {tn}_{3 , l}^{( f )}}{{N}_{3}}}$$

$$for f = 0 , 1 , … , {M}_{υ} - 1 .$$

For coefficients with k_{l,i,f}⁽³⁾=0, amplitude and phase are set to zero, i.e., p_{l,i,f}⁽²⁾=0 and φ_{l,i,f}=0.

The bitmap parameter typeII-RI-Restriction-r16 forms the bit sequence r₃, r₂, r₁, r₀ where r₀ is the LSB and r₃ is the MSB. When rᵢ is zero, i∈{0,1, . . . , 3}, PMI and RI reporting are not allowed to correspond to any precoder associated with ν=i+1 layers.

The bitmap parameter n1-n2-codebookSubsetRestriction-r16 forms the bit sequence B=B₁B₂ and configures the vector group indices g^{(k)} as in clause 5.2.2.2.3 of 3GPP TS 38.214. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i∈{0,1, . . . , L−1}, of the coefficients associated with the vector in group g^{(k)} indexed by x₁, x₂, where the maximum amplitudes are given in Table 9 and the average coefficient amplitude is restricted as follows:

$$\sqrt{\frac{1}{{\sum }_{f = 0}^{{M}_{υ} - 1} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + p L}$$

for l=1, . . . , v, and p=0,1. A UE that does not report the parameter amplitudeSubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

TABLE 9
Maximum allowed average coefficient
amplitudes for restricted vectors

| | Maximum Average |
|---|---|
| Bit | Coefficient Amplitude |
| b₂^{(k, 2(N}^{₁}^{x}^{₂}^{+x}^{₁}⁾⁺¹⁾b₂^{(k, 2(N}^{₁}^{x}^{₂}^{+x}^{₁}⁾⁾ | γ_{i+pL} |
| 00 | 0 |
| 01 | \sqrt{¼} |
| 10 | \sqrt{½} |

The following section describes aspects of NR Rel. 16 Type-II Port Selection Codebooks that may be used for embodiments of the present disclosure. This description is only by way of example, and should not be construed as limiting.

For Type-II Port Selection codebook, only K (where K≤2N₁N₂) beamformed CSI-RS ports are utilized in DL transmission, in order to reduce complexity. The. The K×N₃ codebook matrix per layer takes on the form:

W=W₁^{PS}\tilde{W}₂W_{f}^{H}.

Here, \tilde{W}₂ and W₃ follow the same structure as the conventional NR Rel. 16 Type-II Codebook, where both are layer specific. The matrix W₁^{PS} is a K×2L block-diagonal matrix with the same structure as that in the NR Rel. 15 Type-II Port Selection Codebook.

For 4 antenna ports {3000, 3001, . . . , 3003}, 8 antenna ports {3000, 3001, . . . 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection-r16’.

The number of CSI-RS ports is configured as in Clause 5.2.2.2.4 of 3GPP TS 38.214. The value of d is configured with the higher layer parameter portSelectionSamplingSize-r16, where d∈{1,2,3,4} and d≤L. The values L, β and pᵥ are configured as in Clause 5.2.2.2.5 of 3GPP TS 38.214, where the supported configurations are given in Table 10.

TABLE 10
Codebook parameter configurations for L, β andp_{υ}

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

The UE may report the RI value ν according to the configured higher layer parameter typeII-PortSelectionRI-Restriction-r16. The UE may not report ν>4. The values of R are configured as in Clause 5.2.2.2.5 of 3GPP TS 38.214.

The UE is also configured with the higher layer bitmap parameter typeII-PortSelectionRI-Restriction-r16, which forms the bit sequence r₃, r₂, r₁, r₀, where r₀ is the LSB and r₃ is the MSB. When rᵢ is zero, i∈{0,1, . . . , 3}, PMI and RI reporting are not allowed to correspond to any precoder associated with ν=i+1 layers.

The PMI value corresponds to the codebook indices i₁ and i₂ as reported in the NR Re. 16 Type-II Port Selection Codebook section of 3GPP TS 38.214.

The 2L antenna ports are selected by the index i_{1,1} as in clause 5.2.2.2.4 of 3GPP TS 38.214. Parameters N₃, M_{ν}, Mᵢₙᵢₜᵢₐₗ (for N₃>19) and K₀ are defined as in clause 5.2.2.2.5 of 3GPP TS 38.214. For layer l, l=1, . . . , ν, the strongest coefficient i_{1,8,l}, the amplitude coefficient indicators i_{2,3,l} and i_{2,4,l}, the phase coefficient indicator i_{2,5,l} and the bitmap indicator i_{1,7,l} are defined and indicated as in clause 5.2.2.2.5 of 3GPP TS 38.214, where the mapping from k_{l,p}⁽¹⁾ to the amplitude coefficient p_{l,p}⁽¹⁾ is given in Table 6 and the mapping from k_{l,i,f}⁽²⁾ to the amplitude coefficient p_{l,i,f}⁽²⁾ is given in Table 7.

The number of nonzero coefficients for layer l, Kₗ^{NZ}, and the total number of nonzero coefficients K^{NZ} are defined as in clause 5.2.2.2.5 of 3GPP TS 38.214. The amplitude coefficients pₗ⁽¹⁾ and pₗ⁽²⁾ (l=1, . . . , v) are represented as in clause 5.2.2.2.5 of 3GPP TS 38.214. The amplitude and phase coefficient indicators are reported as in clause 5.2.2.2.5. Codebook indicators i_{1,5} and i_{1,6,l} (l=1, . . . , v) are found in clause 5.2.2.2.5 of 3GPP TS 38.214. The codebooks for 1-4 layers are given in Table 5.2.2.2.6-2 of 3GPP TS 38.214, where vₘ is a P_{CSI-RS}/2-element column vector containing a value of 1 in element (m mod P_{CSI-RS}/2) and zeros elsewhere (where the first element is element 0), and the quantities φ_{l,i,f} and y_{t,l} are defined as in clause 5.2.2.2.5 of 3GPP TS 38.214.

Rel. 17 Type-II Port Selection codebook follows a similar structure as that of Rel. 15 and Rel. 16 port-selection codebooks, as follows: Wₗ=W̅₁^{PS} \tilde{W}_{2,l}W_{f,l}^{H}.

However, unlike Rel. 15 and Rel. 16 Type-II port-selection codebooks, the port-selection matrix W̅₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

### UL NR Transmission

Up to Rel. 16 NR, two transmission modes exist for precoded PUSCH transmission: codebook-based transmission and non-codebook-based transmission. Aspects of these transmission modes may be implemented in embodiments of the present disclosure. A summary describing both modes is provided below.

### Codebook-Based UL Transmission

For codebook based transmission, PUSCH can be scheduled by DCI format 0_0, DCI format 0_1, DCI format 0_2 or semi-statically configured to operate according to Clause 6.1.2.3 of 3GPP TS 38.214. If this PUSCH is scheduled by DCI format 0_1, DCI format 0_2, or semi-statically configured to operate according to Clause 6.1.2.3 of 3GPP TS 38.214, the UE determines its PUSCH transmission precoder based on SRI, TPMI and the transmission rank, where the SRI, TPMI and the transmission rank are given by DCI fields of SRS resource indicator and Precoding information and number of layers in clause 7.3.1.1.2 and 7.3.1.1.3 of 3GPP TS 38.212 for DCI format 0_1 and 0_2 or given by srs-ResourceIndicator and precodingAndNumberOfLayers according to clause 6.1.2.3 of 3GPP TS 38.214. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListForDCI-Format0-2-r16 in SRS-config, respectively. The TPMI is used to indicate the precoder to be applied over the layers {0 . . . ν−1} and that corresponds to the SRS resource selected by the SRI when multiple SRS resources are configured, or if a single SRS resource is configured TPMI is used to indicate the precoder to be applied over the layers {0 . . . ν−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of 3GPP TS 38.211. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

For codebook based transmission, the UE determines its codebook subsets based on TPMI and upon the reception of higher layer parameter codebookSubset in pusch-Config for PUSCH associated with DCI format 0_1 and codebookSubsetForDCI-Format0-2-r16 in pusch-Config for PUSCH associated with DCI format 0_2 which may be configured with ‘fullyAndPartialAndNonCoherent’, or ‘partialAndNonCoherent’, or ‘nonCoherent’ depending on the UE capability. When higher layer parameter ul-FullPowerTransmission-r16 is set to ‘fullpowerMode2’ and the higher layer parameter codebookSubset or the higher layer parameter codebookSubsetForDCI-Format0-2-r16 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission may not expect to be configured by either codebookSubset or codebookSubsetForDCI-Format0-2-r16 with ‘fullyAndPartialAndNonCoherent’.

A UE reporting its UE capability of ‘nonCoherent’ transmission may not expect to be configured by either codebookSubset or codebookSubsetForDCI-Format0-2-r16 with ‘fullyAndPartialAndNonCoherent’ or with ‘partialAndNonCoherent’.

A UE may not expect to be configured with the higher layer parameter codebookSubset or the higher layer parameter codebookSubsetForDCI-Format0-2-r16 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, the UE may be configured with a single SRS-ResourceSet with usage set to ‘codebook’ and only one SRS resource can be indicated based on the SRI from within the SRS resource set. Except when higher layer parameter ul-FullPowerTransmission-r16 is set to ‘fullpowerMode2’, the maximum number of configured SRS resources for codebook based transmission is 2. If aperiodic SRS is configured for a UE, the SRS request field in DCI triggers the transmission of aperiodic SRS resources.

A UE may not expect to be configured with higher layer parameter ul-FullPowerTransmission-r16 set to ‘fullpowerMode1’ and codebookSubset or codebookSubsetForDCI-Format0-2-r16 set to ‘fullAndPartialAndNonCoherent’ simultaneously.

The UE may transmit PUSCH using the same antenna port(s) as the SRS port(s) in the SRS resource indicated by the DCI format 0_1 or 0_2 or by configuredGrantConfig according to clause 6.1.2.3 of 3GPP TS 38.214.

The DM-RS antenna ports {\tilde{p}₀, . . . , \tilde{p}_{ν-1}} in Clause 6.4.1.1.3 of [4] are determined according to the ordering of DM-RS port(s) given by Tables 7.3.1.1.2-6 to 7.3.1.1.2-23 in Clause 7.3.1.1.2 of 3GPP TS 38.212.

Except when higher layer parameter ul-FullPowerTransmission-r16 is set to ‘fullpowerMode2’, when multiple SRS resources are configured by SRS-ResourceSet with usage set to ‘codebook’, the UE may expect that higher layer parameters nrofSRS-Ports in SRS-Resource in SRS-ResourceSet may be configured with the same value for all these SRS resources.

When higher layer parameter ul-FullPowerTransmission-r16 is set to ‘fullpowerMode2’, the UE can be configured with one SRS resource or multiple SRS resources with same or different number of SRS ports within an SRS resource set with usage set to ‘codebook’. Up to 2 different spatial relations can be configured for all SRS resources in the SRS resource set with usage set to ‘codebook’ when multiple SRS resources are configured in the SRS resource set. Subject to UE capability, a maximum of 2 or 4 SRS resources are supported in an SRS resource set with usage set to ‘codebook’.

### DCI Format 0_1

In embodiments using DCI format 0_1, precoding information and number of layers—number of bits may be determined by the following:
0 bits if the higher layer parameter txConfig=nonCodeBook;
0 bits for 1 antenna port and if the higher layer parameter txConfig=codebook;
4, 5, or 6 bits according to Table 7.3.1.1.2-2 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank, and codebookSubset;
4 or 5 bits according to Table 7.3.1.1.2-2A 3GPP TS 38.212 for 4 antenna ports, if txConfig=codebook, ul-FullPowerTransmission-r16=fullpowerMode1, maxRank=2, transform precoder is disabled, and according to the values of higher layer parameter codebookSubset;
4 or 6 bits according to Table 7.3.1.1.2-2B of 3GPP TS 38.212 for 4 antenna ports, if txConfig=codebook, ul-FullPowerTransmission-r16=fullpowerMode1, maxRank=3 or 4, transform precoder is disabled, and according to the values of higher layer parameter codebookSubset;
2, 4, or 5 bits according to Table 7.3.1.1.2-3 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank, and codebookSubset;
3 or 4 bits according to Table 7.3.1.1.2-3A of 3GPP TS 38.212 for 4 antenna ports, if txConfig=codebook, ul-FullPowerTransmission-r16=fullpowerMode1, maxRank=1, and according to whether transform precoder is enabled or disabled, and the values of higher layer parameter codebookSubset;

2 or 4 bits according to Table7.3.1.1.2-4 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank and codebookSubset;
2 bits according to Table 7.3.1.1.2-4A of 3GPP TS 38.212 for 2 antenna ports, if txConfig=codebook, ul-FullPowerTransmission-r16=fullpowerMode1, transform precoder is disabled, maxRank=2, and codebookSubset=nonCoherent;
1 or 3 bits according to Table7.3.1.1.2-5 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank and codebookSubset;
2 bits according to Table 7.3.1.1.2-5A of 3GPP TS 38.212 for 2 antenna ports, if txConfig=codebook, ul-FullPowerTransmission-r16=fullpowerMode1, maxRank=1, and according to whether transform precoder is enabled or disabled, and the values of higher layer parameter codebookSubset;
For the higher layer parameter txConfig=codebook, if ul-FullPowerTransmission-r16 is configured to fullpowerMode2, maxRank is configured to be larger than 2, and at least one SRS resource with 4 antenna ports is configured in an SRS resource set with usage set to ‘codebook’ and an SRS resource with 2 antenna ports is indicated via SRI in the same SRS resource set, then Table 7.3.1.1.2-4 of 3GPP TS 38.212 is used.

For the higher layer parameter txConfig=codebook, if different SRS resources with different number of antenna ports are configured, the bitwidth is determined according to the maximum number of ports in an SRS resource among the configured SRS resources in an SRS resource set with usage set to ‘codebook’. If the number of ports for a configured SRS resource in the set is less than the maximum number of ports in an SRS resource among the configured SRS resources, a number of most significant bits with value set to ‘0’ are inserted to the field.

### DCI Format 0_2

In embodiments using DCI format 0_2, precoding information and number of layers—number of bits may be determined by the following:
0 bits if the higher layer parameter txConfig=nonCodeBook;
0 bits for 1 antenna port and if the higher layer parameter txConfig=codebook;
4, 5, or 6 bits according to Table 7.3.1.1.2-2 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2, and codebookSubset-ForDCIFormat0_2;
4 or 5 bits according to Table 7.3.1.1.2-2A of 3GPP TS 38.212 for 4 antenna ports, if txConfig=codebook, ul-FullPowerTransmission-r16=fullpowerMode1, the values of higher layer parameters maxRankForDCI-Format0-2=2, transform precoder is disabled, and according to the value of higher layer parameter codebookSubsetForDCI-Format0-2;
4 or 6 bits according to Table 7.3.1.1.2-2B of 3GPP TS 38.212 for 4 antenna ports, if txConfig=codebook, ul-FullPowerTransmission-r16=fullpowerMode1, the values of higher layer parameters maxRankForDCI-Format0-2=3 or 4, transform precoder is disabled, and according to the value of higher layer parameter codebookSubsetForDCI-Format0-2;
2, 4, or 5 bits according to Table 7.3.1.1.2-3 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2, and codebookSubset-ForDCIFormat0_2;
3 or 4 bits according to Table 7.3.1.1.2-3A of 3GPP TS 38.212 for 4 antenna ports, if txConfig=codebook, ul-FullPowerTransmission-r16=fullpowerMode1, maxRankForDCI-Format0-2=1, and according to whether transform precoder is enabled or disabled, and the value of higher layer parameter codebookSubsetForDCI-Format0-2;
2 or 4 bits according to Table7.3.1.1.2-4 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2 and codebookSubset-ForDCIFormat0_2;
2 bits according to Table 7.3.1.1.2-4A of 3GPP TS 38.212 for 2 antenna ports, if txConfig=codebook, ul-FullPowerTransmission-r16=fullpowerMode1, transform precoder is disabled, the maxRankForDCI-Format0-2=2, and codebookSubsetForDCI-Format0-2=nonCoherent;
1 or 3 bits according to Table7.3.1.1.2-5 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2 and codebookSubset-ForDCIFormat0_2;
2 bits according to Table 7.3.1.1.2-5A of 3GPP TS 38.212 for 2 antenna ports, if txConfig=codebook, ul-FullPowerTransmission-r16=fullpowerMode1, maxRankForDCI-Format0−2=1, and according to whether transform precoder is enabled or disabled, and the value of higher layer parameter codebookSubsetForDCI-Format0-2.

For the higher layer parameter txConfig=codebook, if ul-FullPowerTransmission-r16 is configured to fullpowerMode2, the values of higher layer parameters maxRankForDCI-Format0-2 is configured to be larger than 2, and at least one SRS resource with 4 antenna ports is configured in an SRS resource set with usage set to ‘codebook’ and an SRS resource with 2 antenna ports is indicated via SRI in the same SRS resource set, then Table 7.3.1.1.2-4 of 3GPP TS 38.212 is used.

For the higher layer parameter txConfig=codebook, if different SRS resources with different number of antenna ports are configured, the bitwidth is determined according to the maximum number of ports in an SRS resource among the configured SRS resources in an SRS resource set with usage set to ‘codebook’. If the number of ports for a configured SRS resource in the set is less than the maximum number of ports in an SRS resource among the configured SRS resources, a number of most significant bits with value set to ‘0’ are inserted to the field.

### Precoding

This section discusses aspects of precoding which may be implemented in some embodiments. The block of vectors [y⁽⁰⁾(i) . . . y^{(ν-1)}(i)]^{T}, i=0,1, . . . , M_{symb}^{layer}−1 may be precoded according to

$$[ \begin{matrix}\begin{matrix}{z}^{( {p}_{0} )} ( i ) \\ ⋮\end{matrix} \\ {z}^{( {p}_{ρ - 1} )} ( i )\end{matrix} ] = W [ \begin{matrix}\begin{matrix}{y}^{( 0 )} ( i ) \\ ⋮\end{matrix} \\ {y}^{( υ - 1 )} ( i )\end{matrix} ]$$

where i=0,1, . . . , M_{symb}^{ap}−1, M_{symb}^{ap}=M_{symb}^{layer}. The set of antenna ports {p₀, . . . , p_{ρ-1}} may be determined according to the procedure in [1].

For non-codebook-based transmission, the precoding matrix W equals the identity matrix.

For codebook-based transmission, the precoding matrix W is given by W=1 for single-layer transmission on a single antenna port, otherwise by Tables 6.3.1.5-1 to 6.3.1.5-7 of 3GPP TS 38.211 with the TPMI index obtained from the DCI scheduling the uplink transmission or the higher layer parameters according to the procedure in 3GPP TS 38.214.

When the higher-layer parameter txConfig is not configured, the precoding matrix W=1.

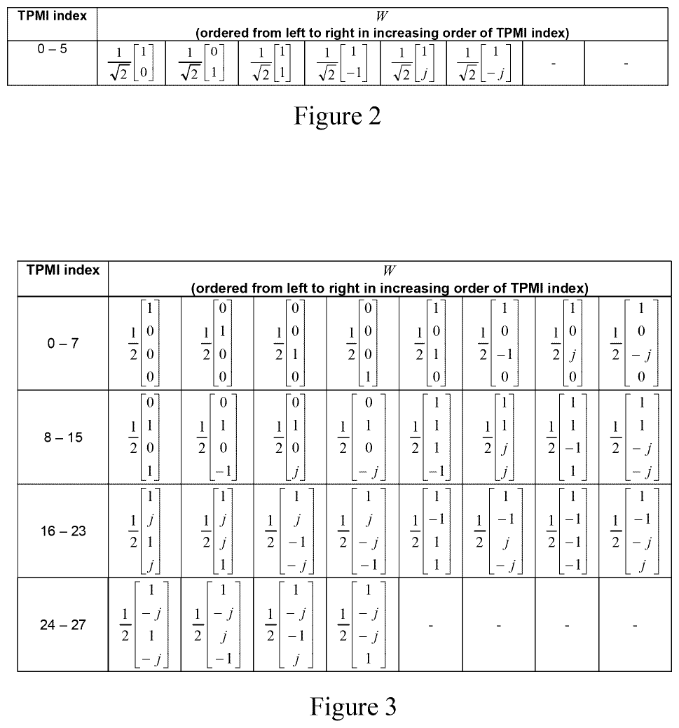

FIGS. 2 to 8 illustrate examples of precoding matrices W that may be used in some embodiments.

FIG. 2 illustrates an example of a precoding matrix for single-layer transmission using two antenna ports in accordance with aspects of the present disclosure.

FIG. 3 illustrates an example of a precoding matrix for single-layer transmission using four antenna ports with transform precoding enabled in accordance with aspects of the present disclosure.

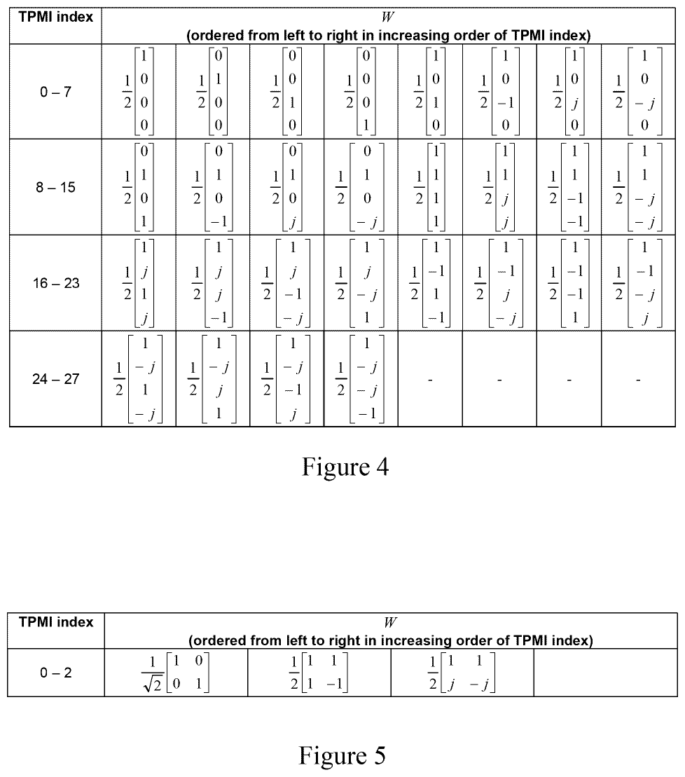

FIG. 4 illustrates an example of a precoding matrix for single-layer transmission using four antenna ports with transform precoding disabled in accordance with aspects of the present disclosure.

FIG. 5 illustrates an example of a precoding matrix for two-layer transmission using two antenna ports with transform precoding disabled in accordance with aspects of the present disclosure.

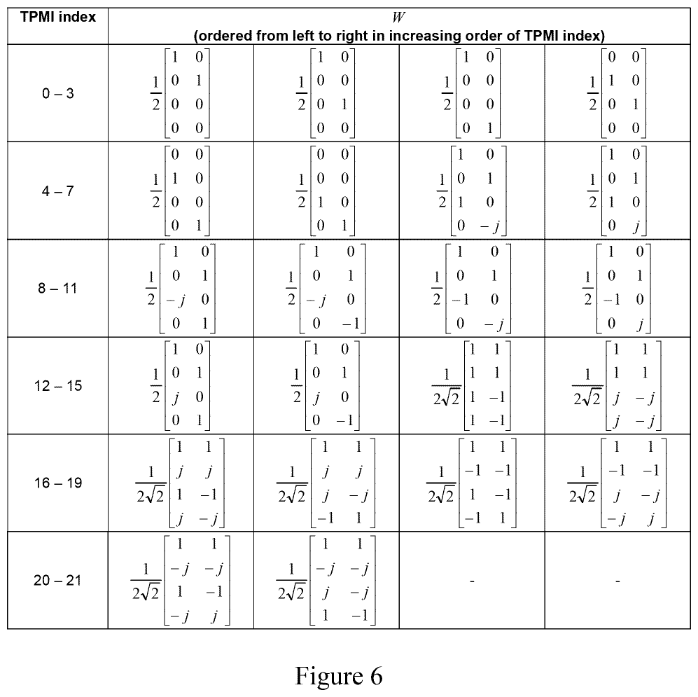

FIG. 6 illustrates an example of a precoding matrix for two-layer transmission using four antenna ports with transform precoding disabled in accordance with aspects of the present disclosure.

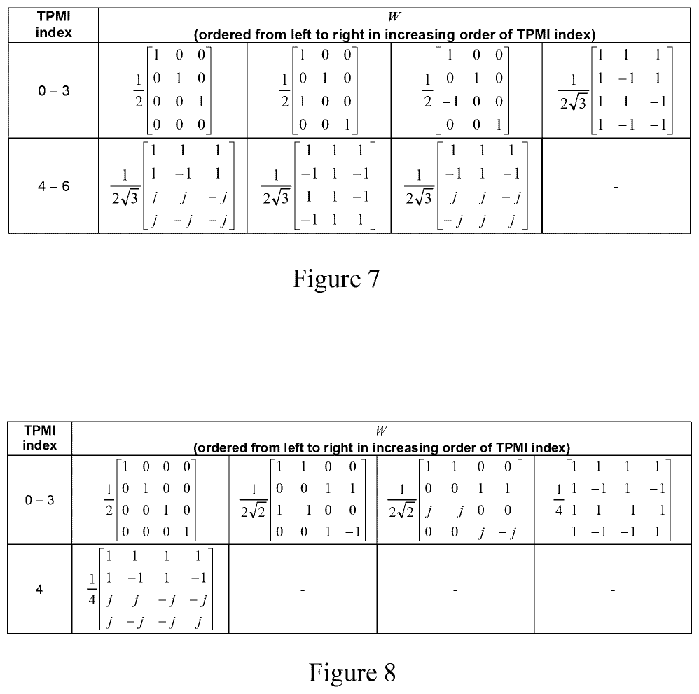

FIG. 7 illustrates an example of a precoding matrix for three-layer transmission using four antenna ports with transform precoding disabled in accordance with aspects of the present disclosure.

FIG. 8 illustrates an example of a precoding matrix for four-layer transmission using four antenna ports with transform precoding disabled in accordance with aspects of the present disclosure.

### Non-Codebook-Based UL Transmission

This section discusses aspects of non-codebook-based UL transmissions which may be implemented in some embodiments.

For non-codebook based transmission, PUSCH can be scheduled by DCI format 0_0, DCI format 0_1, DCI format 0_2 or semi-statically configured to operate according to Clause 6.1.2.3 of 3GPP TS 38.214. If this PUSCH is scheduled by DCI format 0_1, DCI format 0_2, or semi-statically configured to operate according to Clause 6.1.2.3 of 3GPP TS 38.214, the UE can determine its PUSCH precoder and transmission rank based on the SRI when multiple SRS resources are configured, where the SRI is given by the SRS resource indicator in DCI according to clause 7.3.1.1.2 and 7.3.1.1.3 of of 3GPP TS 38.211 for DCI format 0_1 and DCI format 0_2, or the SRI is given by srs-ResourceIndicator according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListForDCI-Format0-2-r16 in SRS-config, respectively. The UE may use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs. Only one SRS port for each SRS resource is configured. Only one SRS resource set can be configured with higher layer parameter usage in SRS-ResourceSet set to ‘nonCodebook’. The maximum number of SRS resources that can be configured for non-codebook based uplink transmission is 4. The indicated SRI in slot n is associated with the most recent transmission of SRS resource(s) identified by the SRI, where the SRS transmission is prior to the PDCCH carrying the SRI.

For non-codebook based transmission, the UE can calculate the precoder used for the transmission of SRS based on measurement of an associated NZP CSI-RS resource. A UE can be configured with only one NZP CSI-RS resource for the SRS resource set with higher layer parameter usage in SRS-ResourceSet set to ‘nonCodebook’ if configured.

The UE may perform one-to-one mapping from the indicated SRI(s) to the indicated DM-RS ports(s) and their corresponding PUSCH layers {0 . . . ν−1} given by DCI format 0_1 or by configuredGrantConfig according to clause 6.1.2.3 of 3GPP TS 38.214 in increasing order.

The UE may transmit PUSCH using the same antenna ports as the SRS port(s) in the SRS resource(s) indicated by SRI(s) given by DCI format 0_1 or by configuredGrantConfig according to clause 6.1.2.3 of 3GPP TS 38.214, where the SRS port in (i+1)-th SRS resource in the SRS resource set is indexed as pᵢ=1000+i.

The DM-RS antenna ports {\tilde{p}₀, . . . , \tilde{p}_{ν-1}} in Clause 6.4.1.1.3 of [4] are determined according to the ordering of DM-RS port(s) given by Tables 7.3.1.1.2-6 to 7.3.1.1.2-23 in Clause 7.3.1.1.2 of of 3GPP TS 38.211. For non-codebook based transmission, the UE does not expect to be configured with both spatialRelationInfo for SRS resource and associatedCSI-RS in SRS-ResourceSet for SRS resource set. For non-codebook based transmission, the UE can be scheduled with DCI format 0_1 when at least one SRS resource is configured in SRS-ResourceSet with usage set to ‘nonCodebook’.

### SRS Configuration

This section discusses aspects of SRS configuration which may be implemented in some embodiments.

As discussed in 3GPP TS 38.214, the UE may be configured with one or more SRS resource sets as configured by the higher layer parameter SRS-ResourceSet, wherein each SRS resource set is associated with K≥1 SRS resources (higher layer parameter SRS-Resource), where the maximum value of K is indicated by UE capability. The SRS resource set applicability is configured by the higher layer parameter usage in SRS-ResourceSet. The higher-layer parameter SRS-Resource configures some SRS parameters, including the SRS resource configuration identity (srs-ResourceId), the number of SRS ports (nrofSRS-Ports) with default value of one, and the time-domain behaviour of SRS resource configuration (resourceType).

The UE may be configured by the higher layer parameter resourceMapping in SRS-Resource with an SRS resource occupying Nₛ∈{1,2,4} adjacent symbols within the last 6 symbols of the slot, where all antenna ports of the SRS resources are mapped to each symbol of the resource.

For a UE configured with one or more SRS resource configuration(s), and when the higher layer parameter resourceType in SRS-Resource is set to ‘aperiodic’:
the UE receives a configuration of SRS resource sets,
the UE receives a downlink DCI, a group common DCI, or an uplink DCI based command where a codepoint of the DCI may trigger one or more SRS resource set(s). For SRS in a resource set with usage set to ‘codebook’ or ‘antennaSwitching’, the minimal time interval between the last symbol of the PDCCH triggering the aperiodic SRS transmission and the first symbol of SRS resource is N₂. Otherwise, the minimal time interval between the last symbol of the PDCCH triggering the aperiodic SRS transmission and the first symbol of SRS resource is N₂+14. The minimal time interval in units of OFDM symbols is counted based on the minimum subcarrier spacing between the PDCCH and the aperiodic SRS.
if the UE is configured with the higher layer parameter spatialRelationInfo containing the ID of a reference ‘ssb-Index’, the UE may transmit the target SRS resource with the same spatial domain transmission filter used for the reception of the reference SS/PBCH block, if the higher layer parameter spatialRelationInfo contains the ID of a reference ‘csi-RS-Index’, the UE may transmit the target SRS resource with the same spatial domain transmission filter used for the reception of the reference periodic CSI-RS or of the reference semi-persistent CSI-RS, or of the latest reference aperiodic CSI-RS. If the higher layer parameter spatialRelationInfo contains the ID of a reference ‘srs’, the UE may transmit the target SRS resource with the same spatial domain transmission filter used for the transmission of the reference periodic SRS or of the reference semi-persistent SRS or of the reference aperiodic SRS.

The update command contains spatial relation assumptions provided by a list of references to reference signal IDs, one per element of the updated SRS resource set. Each ID in the list refers to a reference SS/PBCH block, NZP CSI-RS resource configured on serving cell indicated by Resource Serving Cell ID field in the update command if present, same serving cell as the SRS resource set otherwise, or SRS resource configured on serving cell and uplink bandwidth part indicated by Resource Serving Cell ID field and Resource BWP ID field in the update command if present, same serving cell and bandwidth part as the SRS resource set otherwise.

When the UE is configured with the higher layer parameter usage in SRS-ResourceSet set to ‘antennaSwitching’, the UE may not expect to be configured with different spatial relations for SRS resources in the same SRS resource set.

For PUCCH and SRS on the same carrier, a UE may not transmit SRS when semi-persistent and periodic SRS are configured in the same symbol(s) with PUCCH carrying only CSI report(s), or only L1-RSRP report(s), or only L1-SINR report(s). A UE may not transmit SRS when semi-persistent or periodic SRS is configured or aperiodic SRS is triggered to be transmitted in the same symbol(s) with PUCCH carrying HARQ-ACK, link recovery request (as defined in clause 9.2.4 of [3GPP TS 38.213]) and/or SR. In the case that SRS is not transmitted due to overlap with PUCCH, only the SRS symbol(s) that overlap with PUCCH symbol(s) are dropped. PUCCH may not be transmitted when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s).

When the UE is configured with the higher layer parameter usage in SRS-ResourceSet set to ‘antennaSwitching’, and a guard period of Y symbols is configured according to Clause 6.2.1.2, the UE may use the same priority rules as defined above during the guard period as if SRS was configured.

### UE Sounding Procedure

This section discusses aspects of UE sounding procedures which may be implemented in some embodiments.

When the UE is configured with the higher-layer parameter usage in SRS-ResourceSet set as ‘antennaSwitching’, the UE may be configured with one configuration depending on the indicated UE capability supportedSRS-TxPortSwitch, which takes on the values {‘t1r2’, ‘t1r1-t1r2’, ‘t2r4’, ‘t1r4’, ‘t1r1-t1r2-t1r4’, ‘t1r4-t2r4’, ‘t1r1-t1r2-t2r2-t2r4’, ‘t1r1-t1r2-t2r2-t1r4-t2r4’, ‘t1r1’, ‘t2r2’, ‘t1r1-t2r2’, ‘t4r4’, ‘t1r1-t2r2-t4r4’}.

For 1T2R, up to two SRS resource sets configured with a different value for the higher layer parameter resourceType in SRS-ResourceSet set, where each set has two SRS resources transmitted in different symbols, each SRS resource in a given set consisting of a single SRS port, and the SRS port of the second resource in the set is associated with a different UE antenna port than the SRS port of the first resource in the same set, or

For 2T4R, up to two SRS resource sets configured with a different value for the higher layer parameter resourceType in SRS-ResourceSet set, where each SRS resource set has two SRS resources transmitted in different symbols, each SRS resource in a given set consisting of two SRS ports, and the SRS port pair of the second resource is associated with a different UE antenna port pair than the SRS port pair of the first resource, or

For 1T4R, zero or one SRS resource set configured with higher layer parameter resourceType in SRS-ResourceSet set to ‘periodic’ or ‘semi-persistent’ with four SRS resources transmitted in different symbols, each SRS resource in a given set consisting of a single SRS port, and the SRS port of each resource is associated with a different UE antenna port, and

For 1T4R, zero or two SRS resource sets each configured with higher layer parameter resourceType in SRS-ResourceSet set to ‘aperiodic’ and with a total of four SRS resources transmitted in different symbols of two different slots, and where the SRS port of each SRS resource in the given two sets is associated with a different UE antenna port. The two sets are each configured with two SRS resources, or one set is configured with one SRS resource and the other set is configured with three SRS resources.

For 1T=1R, or 2T=2R, or 4T=4R, up to two SRS resource sets each with one SRS resource, where the number of SRS ports for each resource is equal to 1, 2, or 4.

The UE is configured with a guard period of Y symbols, in which the UE does not transmit any other signal, in the case the SRS resources of a set are transmitted in the same slot. The guard period is in-between the SRS resources of the set. The value of Y is 2 when the OFDM sub-carrier spacing is 120 kHz, otherwise Y=1.

For 1T2R, 1T4R or 2T4R, the UE may not expect to be configured or triggered with more than one SRS resource set with higher layer parameter usage set as ‘antennaSwitching’ in the same slot. For 1T=1R, 2T=2R or 4T=4R, the UE may not expect to be configured or triggered with more than one SRS resource set with higher layer parameter usage set as ‘antennaSwitching’ in the same symbol.

### Antenna Panel/Port, Quasi-Collocation, TCI State, and Spatial Relation

This section discusses aspects of antenna panels and ports, quasi-collocation, TCI state, and spatial relation which may be implemented in some embodiments.

In some implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to a gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports may be said to be quasi co-located (QCL) if large-scale properties of the channel over which a symbol on one antenna port is conveyed can be inferred from the channel over which a symbol on the other antenna port is conveyed. The large-scale properties may include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same RX beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source RS to provide a reference (UE assumption) for determining QCL and/or spatial filter.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signalling. The UL TCI state may comprises a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the implementations described, a joint DL/UL TCI state is provided if the device is configured with joint DL/UL TCI by RRC signalling (e.g., configuration of joint TCI or separate DL/UL TCI is based on RRC signalling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Several approaches are possible for efficiently managing UL transmissions over multiple antenna ports. The different approaches accommodate a balance between UL codebook performance and the corresponding signaling overhead for different antenna configurations and coherence assumptions at a UE 104. In more detail, there are at least two categories of approaches, which can be broadly characterized as open-loop precoding and closed-loop precoding. Open-loop precoding may be more suitable for channel conditions that change relatively quickly over time, such as in a mobility situation, and may use reduced UL signaling from a UE 104 to feedback channel information to a NE 102. Closed-loop precoding may be more suitable for relatively stable channel conditions and may use greater amounts of UL signaling from the UE 104 to the NE 102 than open-loop precoding.

### Open-Loop Precoding

In embodiments of the present disclosure, open-Loop precoding may include transmitting signals from a UE 104 using Space-Frequency Block Coding (SFBC). In some implementations, Sounding Reference Signals (SRS) may be transmitted from the UE 104 to an NE 102 and used by the NE 102 to determine at least one of a Modulation and Coding Scheme (MCS) level, a modulation order applied to a sequence of symbols transmitted by the UE 104, a channel code rate applied to the sequence of data symbols, or a combination thereof. In some implementations, Demodulation Reference Signals (DMRS) may be used for per-antenna port channel estimation of a Physical Uplink Shared Channel (PUSCH). SFBC may be implemented by a UE 104 across different sub-carriers to improve coverage. Details of how an open-loop precoding scheme may be implemented in various embodiments will be apparent based on the following disclosure.

Open-loop precoder schemes are not limited to using SFBC. For example, another type of open-loop precoder scheme is precoder cyclic where a first precoder is used on a first set of symbols on a first frequency resource and a second precoder is used on second set of symbols on a second frequency resource.

A UE 104 may receive a configuration signal from a NE 102 indicating a precoding scheme for transmitting a sequence of data symbols over a set of antenna ports and a set of frequency resources for UL transmissions. In some implementations, the precoding scheme may be an SFBC scheme. The precoding scheme may be an open-loop scheme, e.g., a precoding scheme which does not rely on ongoing feedback from the NE 102 to the UE 104 for precoding conditions of the UE 102. In some examples, the open-loop scheme such as transmit diversity may be useful when no feedback signaling from NE 102 to the UE 104 is available (e.g., information on the channel conditions from UE 104 to NE 102 is not available) or when the feedback is not sufficiently accurate such as at high speeds.

The following simple example illustrates an SFBC scheme for which the channels associated with Port 0 and Port 1 are h₀, h₁, respectively:

| | Frequency | Frequency |
|---|---|---|
| | Resource 0 | Resource 1 |
| Port 0 | X₀ | X₁ |
| Port 1 | −X₁* | X₀* |

In this example, the received signal at each of the frequency resources is as follows:

$$[ \begin{matrix}{y}_{0} \\ {y}_{1}\end{matrix} ] = {h}_{0} \cdot [ \begin{matrix}{x}_{0} \\ {x}_{1}\end{matrix} ] + {h}_{1} \cdot [ \begin{matrix}- {x}_{1}^{⋆} \\ {x}_{0}^{⋆}\end{matrix} ] + [ \begin{matrix}{w}_{0} \\ {w}_{1}\end{matrix} ]$$

In the presence of knowledge of h₀, h₁ at a receiver (e.g., a UE 104), the receiver can perform the following calculations to obtain estimates \hat{x}₀, \hat{x}₁ of the symbols x₀, x₁, respectively, as follows:

$${\hat{x}}_{0} = \frac{1}{{( \vert {h}_{0} \vert}^{2} + {\vert {h}_{1} \vert}^{2} )} ( {h}_{0}^{*} {y}_{0} + {h}_{1} {y}_{0}^{*} ) = {x}_{0} + \frac{{h}_{0}^{*} {w}_{0} + {h}_{1} {w}_{1}^{*}}{( {\vert {h}_{0} \vert}^{2} + {\vert {h}_{1} \vert}^{2} )} ,$$

$${\hat{x}}_{1} = \frac{1}{( {\vert {h}_{0} \vert}^{2} + {\vert {h}_{1} \vert}^{2} )} ( {h}_{0}^{*} {y}_{1} - {h}_{1} {y}_{0}^{*} ) = {x}_{1} + \frac{{h}_{0}^{*} {w}_{0} - {h}_{1} {w}_{1}^{*}}{( {\vert {h}_{0} \vert}^{2} + {\vert {h}_{1} \vert}^{2} )} .$$

The signals may be transmitted by a UE 104 over different frequencies at the same time, where noise variance is minimized. In the equations above, * represents a complex conjugate value. In some implementations, at least a portion of a sequence of symbols transmitted by a UE 104 have complex values, and a transformed function of a first symbol may be a conjugate transposition transformation.

Accordingly, in some embodiments, referring to the SFBC scheme above, transmitting each symbol in a sequence of symbols transmitted from a UE 104 includes transmitting a first symbol (e.g., X₀) using a first port of the at least two antenna ports and a first frequency resource of the at least two frequency resources, and transmitting a transformed function of the first symbol (e.g., X₀*) using a second port of the at least two antenna ports and a second frequency resource of the at least two frequency resources. Transmitting the sequence of symbols may further include transmitting a second symbol (e.g., X₁) using the first port and the second frequency resource, and transmitting a transformed function of the second symbol using the second port and the first frequency resource (e.g., −X₁*), wherein the transformed function of the second symbol is the same transformed function as the transformed function of the first symbol except for a phase offset. In some examples, the transformed function of the first symbol is a conjugate transposition transformation. In some examples, the phase offset is 180 degrees or negative of the transformed function of the first symbol.

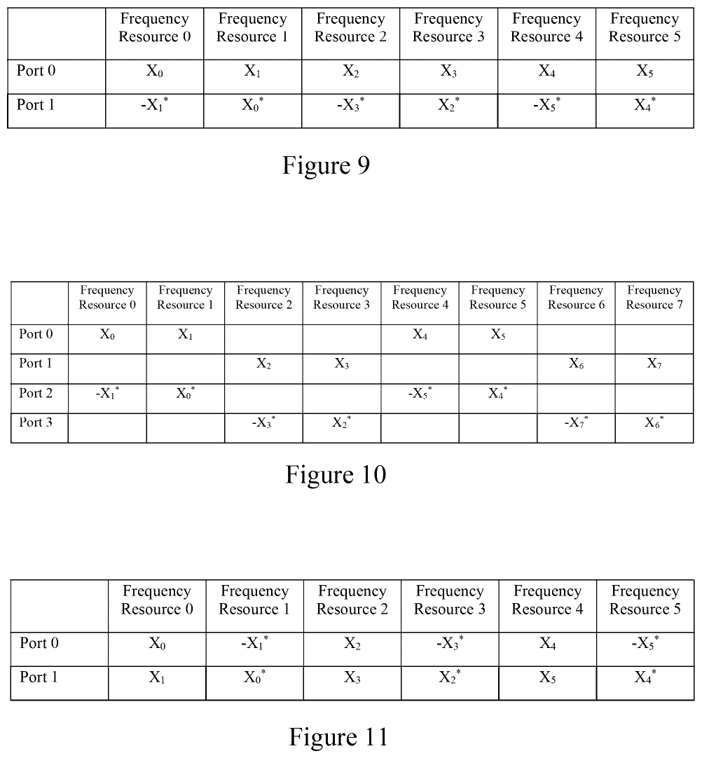

Port mapping may vary depending on the number of frequency resources. FIG. 9 illustrates an example of a mapping of 6 symbols x₀, x₁, . . . , x₅, over six frequency resources in accordance with aspects of the present disclosure.

Port mapping may also vary based on the number of ports used by a UE 104. FIG. 10 illustrates an example of a mapping of 6 symbols x₀, x₁, . . . , x₅, over six frequency resources and four ports in accordance with aspects of the present disclosure.

FIG. 11 illustrates an example of an alternative implementation, and in particular, a mapping of 6 symbols x0, x1, . . . , x5, over 6 frequency resources in accordance with aspects of the present disclosure that is different from that of FIG. 9.

A UE 104 may be configured by a NE 102 with an SRS configuration comprising one or more SRS resources. Each SRS resource may be associated with an SRS port. Upon receiving the SRS ports in a configuration signal from a NE 102, the UE 104 may be further configured with a DCI signal, or a configured-grant (CG) PUSCH grant that configures the UE 104 with SFBC-based UL transmissions.

In a first implementation, a UE 104 is configured with transmitting two streams of data corresponding to two antenna ports by a configuration signal from a NE 102.

In some implementations, a number of DMRS ports for PUSCH may be equal to the number of antenna ports, wherein each DMRS of the DMRS ports is associated with a distinct antenna port. For example, a UE 104 with four antenna ports may transmit four DMRSs from the respective antenna ports.

In some examples, the DMRS ports may be multiplexed (e.g., orthogonal multiplexing) in frequency (e.g., on different sets of subcarriers or different combs in frequency), code domain e.g., using orthogonal cover codes such as Walsh/Hadamard codes on two or more DMRS symbols in the time-domain, on two or more DMRS REs (Resource Elements or subcarriers) in the frequency domain, or a combination thereof. In some examples, the DMRS transmissions on the DMRS ports may be unprecoded. The UE 104 may transmit a first DMRS from a first antenna port, and a second DMRS from a second antenna port.

In some implementations, the number of DMRS ports may be equal to the number of SRS ports across one or more SRS resources, wherein the DMRS ports are port-wise quasi co-located (QCLed) with the SRS ports. For example, when k ports are used, a first DMRS port is QCLed with a first SRS port, . . . , a k^{th} DMRS port is QCLed with a k^{th} SRS port, . . . , etc. The QCL relationship may be of Type-A, and Type-D in some embodiments.

In some implementations, two DMRS ports of the DMRS ports are QCLed with respect to at least average delay and delay spread characteristics. Each DMRS port of the DMRS ports may be QCLed with a respective SRS port, and a mapping of the DMRS ports and SRS ports may be based on identifier values of the DMRS ports, identifier values of the SRS ports, or both. These identifier values may identify specific DMRS ports and SRS ports in a set of antenna ports.

In some implementations, the QCL is with respect to average delay, delay spread, Doppler shift, Doppler spread, average gain, or spatial parameter, as known in the art, or a combination these characteristics. For example, two DMRS ports may be QCLed with respect to at least average delay and delay spread, e.g., QCL Type-A.

The two DMRS ports may be further mapped to each stream of data of the two streams of data. In one example, the mapping is in a form of spatial information. In another example, the mapping is in a form of a correlation function.

For PUCCH transmissions from the UE 104, a single DMRS port of a set of DMRS ports may be utilized for control signal transmissions.

Data streams from a UE 104 may be mapped to layers or symbols by multiplexing. In some implementations, two streams of data transmitted from a UE 104 are multiplexed over two frequency resources, e.g., two subcarriers or sets of subcarriers. A first combination of symbols of the two layers of data may be transmitted over a first of the two frequency resources, and a second combination of symbols of the two layers of data may be transmitted over a second of the two frequency resources.

In a first example, the two streams of data are associated with two PUSCH data layers. In a second example, the two streams of data are associated with different symbols of a same PUSCH data layer. In a third example, the two frequency resources are two contiguous Resource Block (RB) groups, wherein each RB group of the two contiguous RB groups comprises at least one RB. In a fourth example, the two frequency resources are two contiguous RBs. In a fifth example, the two frequency resources are two groups of sub-carriers within the same RB, and each group of sub-carriers comprises at least one sub-carrier.

In some implementations, each antenna port of a set of antenna ports of a UE 104 may be associated with a distinct SRS partition, and each SRS partition may be QCLed with a distinct DMRS port for PUSCH transmissions. In a first example, an SRS partition is an SRS port, and the distinct SRS partitions are associated with a same SRS resource. In a second example, an SRS partition is an SRS resource, and the distinct SRS partitions are associated with a same SRS resource set.

In some implementations, the UE 104 is configured with an SRS usage value set to ‘none’, for which no SRS is configured to be transmitted associated with the uplink transmission.

In some other implementations, the UE 104 is configured with an SRS usage value set to ‘SFBC’, referring to Space-Frequency Block Coding, and a density of the SRS in the frequency domain, corresponding to a comb structure of the SRS, may depend on a granularity of the frequency resource. A frequency hopping approach for which an SRS occupies alternating sub-carriers may be supported according to the density of the SRS in the frequency domain.

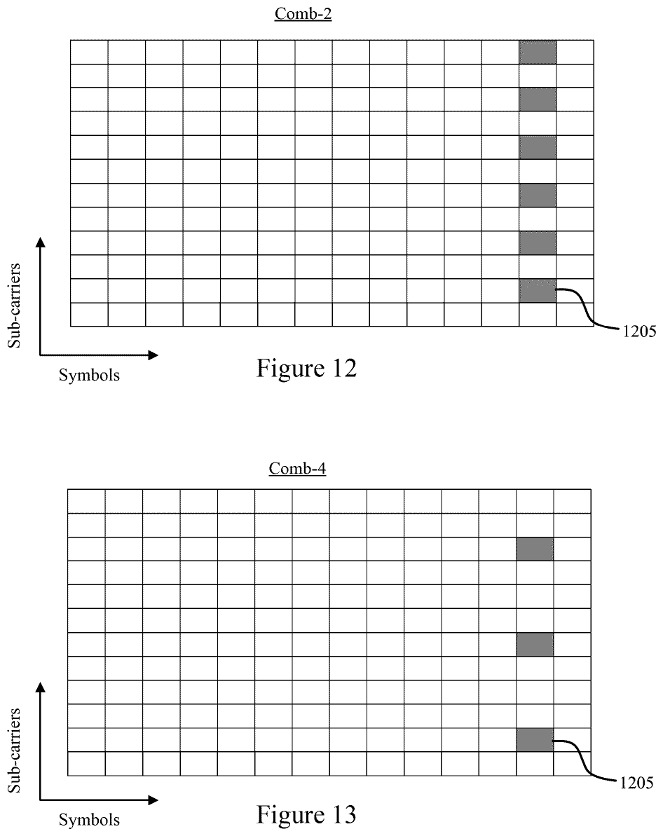

FIG. 12 illustrates an example of a comb-2 structure with SRS symbols 1205 present in every two consecutive sub-carriers in accordance with aspects of the present disclosure. FIG. 12 shows a slot/RB grid in which horizontal blocks (forming one row) correspond to (14) symbols over the slot, and (12) vertical blocks (forming one column) correspond to sub-carriers over the RB.

In a first example, an SRS with a comb-2 structure in which the SRS symbols 1205 occupy every other sub-carrier, e.g., even numbered subcarriers only, is configured when a granularity of the frequency resource is a single sub-carrier. According to a frequency hopping approach, the SRS 1205 would alternate between occupying even-numbered sub-carriers and odd-numbered subcarriers across slots carrying the SRS.

FIG. 13 illustrates an example of Comb-4 structure with SRS symbols 1205 present in every four consecutive sub-carriers in accordance with aspects of the present disclosure. An implementation in which the SRS 1205 occupies every four sub-carriers (subcarriers 4m+δ for a fixed δ value, e.g., 1,5,9, . . . , for m=0,1,2, and δ=) may be configured when a granularity of the frequency resource is two sub-carriers. According to the frequency hopping approach, the SRS 1205 would alternate between occupying slot numbers 4m+δ, where a value of δ alternates between 0,1,2, and 3 across successive slots carrying the SRS 1205.

In some implementations, a UE 104 may select a comb structure of a set of SRSs 1205 based on a size of the set of antenna ports (i.e., number of antenna ports in the set of antenna ports) used to transmit an associated sequence of data symbols. An index offset value associated with the comb structure of the set of SRS 1205 may change across time slots carrying the set of SRSs as described above. In one example, a comb-two structure of two is utilized for a system with 2 antenna ports, whereas a comb-four structure of two is utilized for a system with 4 antenna ports.

In some implementations, an SRS 1205 transmitted from the UE 104 is utilized to identify a signal modulation index, a channel code rate index, or a combination thereof, to be used for uplink signalling, depending on the channel sounding measurement based on a received measured power from the SRS 1205. Furthermore, the SRS 1205 may help identify a coherence bandwidth of the channel corresponding to a largest frequency band under which the channel response is flat, so as to enable pursuing vector-based transformation, i.e., each of X₀, X₁ is a sequence of symbols for which the transformation is pursued in a vector-based approach for computation efficiency purposes.

The DMRS may be associated with PUSCH transmission or PUCCH transmission, with the objective of enabling UL channel estimation per antenna port wherein each antenna port is associated with a distinct DMRS port, and hence a number of layers transmitted in UL may not be equal to a number of the distinct DMRS ports. In some implementations, a number of layers is equal to one.

The SRS ports may be pairwise QCLed with the DMRS ports, e.g., a first SRS port in a first configured SRS resource is QCLed with a first DMRS port, a a second SRS port in a first configured SRS resource is QCLed with a second DMRS port, etc., wherein a total number of SRS ports over the configured SRS resources is equal to the total number of DMRS ports. A value of a power offset between SRS and DMRS for PUSCH may be signaled by the UE or configured by the network.

### Closed-Loop Precoding

Embodiments of the present disclosure include closed-loop implementations in which a UE 104 transmits reference signals (e.g., SRS) to a NE 102, and the UE 104 receives a precoding configuration from the NE 102 for a precoding matrix based on the reference signals. In particular, the UE 104 may receive a UL codebook configuration comprising at least a Transmitted Precoding Matrix Indicator (TPMI) from the NE 102. The UL codebook configuration may comprise additional information, including at least one of a signal modulation indicator, a channel code rate indicator, and a rank indicator.

Two approaches to closed-loop precoding are discussed below, including a shared TPMI over multiple slots and differential TPMI. These approaches are not mutually exclusive, and various aspects of one or both approaches may be implemented in some embodiments.

### Shared TPMI

This section discusses closed-loop UL precoding with PMI-common signaling for multiple slots. For high-resolution TPMI, the precoding matrix is not expected to vary across slots, and therefore a UE 104 scheduled with PUSCH transmissions by multiple DCI signals, or by Configured-Grant PUSCH (CG-PUSCH) may not benefit from slot-specific TPMI. Instead, the UE 104 may be configured with a common TPMI that is applicable for UL precoding within a configured time window for UL transmissions.

In one implementation, a UE 104 is configured with receiving a DCI carrying TPMI corresponding to one or more subbands, wherein each frequency subband is associated with a distinct precoding matrix.

In an embodiment, a DCI signal carrying the TPMI does not schedule Physical Downlink Shared Channel (PDSCH) reception at the UE 104 or PUSCH transmissions by the UE 104. The DCI may comprise multiple TPMI fields associated with one or more frequency sub-bands, one or more layers, or a combination thereof. In some examples, a number of layers across TPMI fields in a plurality of sub-bands is fixed.

In a first example, the multiple TPMI fields are reported separately such that a distinct TPMI is signaled for each frequency sub-band. In a second example, the multiple TPMI fields are jointly designed via a frequency domain transformation matrix that spans the multiple frequency sub-bands.

In some implementations, the DCI corresponding to TPMI reporting comprises two DCI parts, including a first part and a second part. The first part may indicate a number of layers associated with the TPMI, information identifying a size of a subsequent second part of the DCI (e.g., a size of the TPMI in the second part of the DCI, corresponding to a total number of bits characterizing the TPMI), a TPMI codebook type, a number of layers included in the TPMI, a modulation index, a channel coding index, or a combination thereof. The second DCI part may comprise the TPMI information.

In some examples, the UE 104 acknowledges the DCI carrying the TPMI (and does not schedule PDSCH reception at the UE 104 or PUSCH transmissions) by transmitting a positive HARQ-ACK. The HARQ-ACK may be transmitted on a Physical Uplink Control Channel (PUCCH) or PUSCH.

A TPMI received by a UE 104 may have a limited validity duration. The validity duration may be, for example, one or more of the following:
1) a configured time threshold (e.g., configured by a signal received from a NE 102) from a time at which a DCI carrying the TPMI is received by the UE 104,
2) a fixed time threshold from the time at which a DCI carrying the TPMI is received by the UE 104,
3) a validity duration that is terminated by receiving a subsequent DCI carrying a new TPMI for the PUSCH,
4) a validity duration that is terminated by receiving a deactivation or deconfiguration signal associated with the DCI carrying the TPMI.
5) a validity duration that starts from a first slot (or subframe or generally a container comprising a plurality of symbols) that is an offset (e.g., in number of symbols e.g., 4 symbols) after the last symbol of the PUCCH or the PUSCH carrying the positive HARQ-ACK acknowledging the DCI carrying the TPMI.

Accordingly, in some implementations, at least one field (or a codepoint corresponding to a particular value of a bit field) in an UL codebook configuration terminates the validity of at least one corresponding field of a prior UL codebook configuration. In one example, a first rank indicator value corresponding to a number of layers supported for UL transmission within a later codebook configuration terminates the validity of a corresponding second rank indicator value corresponding to a number of layers supported for UL transmission within an earlier codebook configuration.

In some implementations, The TPMI included in the DCI may be invalid starting from a time instant at which the UE 104 switches to idle mode, inactive mode, or goes in a sleep mode, e.g., a period of an inactive time of a discontinuous reception (DRX) cycle.

A TPMI received by a UE 104 may be applied starting from a first slot (or subframe, or more generally, a container comprising a plurality of symbols) that is offset by a number of symbols after the last symbol of the PUCCH or the PUSCH carrying the positive HARQ-ACK acknowledging the DCI carrying the TPMI for the UE 104. In one example, the number of symbols is 8. In other examples, the number of symbols is a multiple of 14.

In some examples, if the UE 104 receives a DCI carrying a TPMI for a subset of the one or more frequency sub-bands, one or more layers, or a combination thereof, the UE 104 updates the indicated TPMI for the subset of the one or more frequency sub-bands, one or more layers, or a combination thereof, and keeps or maintains the previously indicated TPMIs for one or more frequency sub-bands, one or more layers, or a combination thereof that are not updated. In some examples, the previously indicated TPMIs may be indicated in a previous DCI carrying the TPMIs.

In some implementations, the DCI carrying the TPMI is associated with an identifier (ID) value, and a subsequent DCI for scheduling PUSCH transmissions comprises a codepoint associated with a DCI ID value corresponding to the DCI carrying the TPMI, wherein the DCI carrying the TPMI is received no later than a DCI for scheduling PUSCH transmissions.

For example, in a first step, an ID may be associated to a configuration message carrying a PMI. An ID in the configuration message may comprise a sequence of TPMIs corresponding to a sequence of precoders used over multiple frequency sub-bands, such that the configuration ID is a simplified, smaller ID in length (compared to a conventional ID) mapping to a prior set of indicated TPMIs. In a second step, the PMI may be automatically assigned the same ID, since there is only one TPMI configured. An NE 102 may use the configuration ID to refer to a given precoding matrix. In some examples, a configuration ID is associated with a codebook configuration message carrying multiple TPMIs for multiple sub-bands, wherein the configuration ID now jointly maps to the multiple TPMIs corresponding to a sequence of precoders used over the multiple sub-bands, i.e., the configuration ID is then a single codepoint that maps to a pre-configured, set of multiple TPMIs, i.e., a sequence of TPMI values. The NE would then use the configuration ID to refer to this set of multiple TPMIs in subsequent communication with the UE.

In some examples, the UE 104 may receive a DCI for scheduling PUSCH transmission(s), and the DCI comprises a precoding information field. In some cases, a first codepoint of the precoding information field may indicate the UE 104 that the most recent received DCI carrying the TPMI is applicable to the scheduled PUSCH. In one example, the precoding information field indicating codepoints other than the first codepoint may indicate to the UE 104 the TPMI to use for the scheduled PUSCH. In one example, the precoding information field indicating codepoints other than the first codepoint may indicate to the UE 104 that the DCI scheduling PUSCH includes a TPMI to use for the scheduled PUSCH.

### Structure of TPMI

A UE 104 configured with PUSCH transmissions via codebook-based precoding may also configured with a codebook type, and the codebook type may be based on a value of at least one parameter of a set of parameters associated with an antenna configuration at a UE 104. Several possible implementations that describe different codebook structures and their relationship with antenna configurations are described below. In some embodiments, one or more elements or features from one or more of the implementations described below may be combined.

In a first implementation, the UE 104 is configured with an UL TPMI codebook of a set of codebook types. The configured UL TPMI codebook type may be indicated as part of the PUSCH configuration, as part of the DCI carrying the multiple TPMI fields, or a combination thereof.

Each frequency sub-band may be associated with a distinct TPMI index from a set of multiple TPMI indices. For instance, a Bandwidth Part (BWP) with K sub-bands may be associated with K precoding matrices W₁, W₂, . . . , W_{K}, each indicated separately, and each precoding matrix Wₖ may be selected from a list of precoding matrices. Examples of precoding matrices which may be appropriate for this implementation are shown in FIGS. 3, 4, 7 and 8.

In a second implementation, the set of codebook types comprises a Discrete Fourier Transform (DFT)-based codebook type.

In a first example, a DFT-based codebook type using eight antenna ports is based on the 3GPP Rel-15 DL Type-I codebook, wherein a spatial transformation matrix is a block-diagonal matrix with two identical diagonal blocks corresponding to a DFT matrix, as follows:

$${W}_{1} = [ \begin{matrix}B & 0 \\ 0 & B\end{matrix} ]$$

The matrix B is a matrix whose columns are selected from a DFT matrix of size 4×4.

In a second example, the DFT-based codebook type using eight antenna ports is based on the 3GPP Rel-15 DL Type-I codebook, and a spatial transformation matrix is based on a matrix B, i.e., W₁=B and the columns of B are selected from a DFT matrix of size 8×8.

In a third example, the matrix B is an N₁N₂×L matrix with L N₁N₂ columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

In a fourth example, the matrix B is an N×L matrix with L≤N columns drawn from an oversampled DFT matrix, as follows:

$${u}_{m} = [ \begin{matrix}1 & {e}^{j \frac{2 π m}{O N}} & … & {e}^{j \frac{2 π m ( N - 1 )}{O N}}\end{matrix} ] ,$$

$$- ,$$

$$B = [ \begin{matrix}{u}_{{m}_{0}} & {u}_{{m}_{1}} & … & {u}_{{m}_{L - 1}}\end{matrix} ] ,$$

$${m}_{i} = {On}^{( i )} + q , 0 \leq {n}^{( i )} < N , 0 \leq q < O - 1$$

The DFT-based codebook type may further comprise a frequency-domain transformation matrix, as follows:

W=W₁\tilde{W}₂W_{f}^{H},

where W₁ meets the definition above, and W_{f} is an N₃×M matrix (M<N₃) with columns selected from a critically-sampled size-N₃ DFT matrix, as follows:

$${W}_{f} = [ \begin{matrix}{f}_{{k}_{0}} & {f}_{{k}_{1}} & … & {f}_{{k}_{{M}^{′} - 1}}\end{matrix} ] , 0 \leq {k}_{i} < {N}_{3} - 1 ,$$

$${f}_{k} = [ \begin{matrix}1 & {e}^{- j \frac{2 π k}{{N}_{3}}} & … & {e}^{{- j \frac{2 π k ( {N}_{3} - 1 )}{{N}_{3}} ]}^{T}} ,\end{matrix}$$

in which the superscript ^{T} denotes a matrix transposition operation. Only the indices of the M selected columns out of the predefined size-N₃ DFT matrix may be reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

Here, coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported.

In a third implementation, the UE 104 is associated with a selected codebook type of a set of codebook types, and the selected codebook type is set by a rule based on at least one of an antenna configuration, a number of antenna ports, a number of SRS resource sets associated with the TPMI, a number of SRS resources associated with the TPMI, a number of TPMI, a number of antenna groups, a number of coherence groups, or a combination thereof.

In a first example, an antenna configuration with 8 antenna ports and a plurality of antenna groups of which a number of antenna ports in each antenna group is two, corresponds to a Rel-15 UL based codebook type with transform precoding disabled. In a second example, an antenna configuration with 8 antenna ports and at least one antenna group of which a number of antenna ports in each antenna group is no less than four, corresponds to a DFT-based codebook type. In a third example, an antenna configuration with 8 antenna ports, one coherence group and no more than two antenna groups, corresponds to a DFT-based codebook type. In a fourth example, an antenna configuration with 8 antenna ports and more than two coherence groups corresponds to a Rel-15 UL based codebook type with a transform precoding disabled. In a fifth example, an antenna configuration with 8 antenna ports and 8 coherence groups corresponds to an antenna selection-based codebook type.

### Differential TPMI

To maintain DCI overhead balanced for sub-band based closed-loop TPMI reporting, differential reporting of a TPMI may be implemented in some embodiments by fragmenting the TPMI based on alternating sub-bands reported over different slots. For example, the first TPMI received over the first iteration, e.g., over odd sub-bands, may be utilized for the entire bandwidth by precoding extrapolation.

In an implementation of differential TPMI, the TPMI included in a first UL codebook configuration may correspond to a first subset of a set of frequency resources, and TPMI included in a second UL codebook configuration may correspond to a second subset of the set of frequency resources. The first subset of frequency resources may be different from the second subset of frequency resources such that the first subset of frequency resources do not overlap with the second subset of the set of frequency resources in the frequency domain.

In some implementations, a UE 104 is configured with receiving multiple DCIs scheduling PUSCH transmissions over multiple slots. Each DCI of the multiple DCIs may carry a partial TPMI, e.g., a TPMI for a portion or subset of a set frequency resources, and the multiple partial TPMIs constitute a TPMI for multiple sets of frequency resources. In the following example, partial TPMIs are carried by three different DCI signals for a set of frequency resources.

In the example, a first DCI carries TPMI associated with a first subset of the set of the frequency resources. The first subset of the set of the frequency resources is associated with 1) a first index offset of a first frequency resource in the first subset of the set of the frequency resources, and 2) a first step value associated with a difference in index of a given frequency resource with a subsequent frequency resource in the first subset of the set of the frequency resources.

A second DCI carries TPMI associated with a second subset of the set of the frequency resources. The second subset of the set of the frequency resources is associated with 1) a second index offset of a first frequency resource in the second subset of the set of the frequency resources, and 2) a second step value associated with a difference in index of a given frequency resource with a subsequent frequency resource in the second subset of the set of the frequency resources.

A third DCI carries TPMI associated with a third subset of the set of the frequency resources. The third subset of the set of the frequency resources is associated with 1) a third index offset of a first frequency resource in the third subset of the set of the frequency resources, and 2) a third step value associated with a difference in index of a given frequency resource with a subsequent frequency resource in the second subset of the set of the frequency resources.

In an illustrative example, a BWP with 12 frequency resources is associated with three subsets of sets of frequency resources indexed 0, 1, . . . , 11. In this example, the first subset of the set of the frequency resources comprises frequency resources indexed 0,3,6,9; the second subset of the set of the frequency resources comprises frequency resources indexed 1,4,7,10; and the third subset of the set of the frequency resources comprises frequency resources indexed 2,5,8,11.

Each DCI of the multiple DCIs may carry one or more TPMI associated with one or more frequency resources in the respective subset of the set of the frequency resources. In some implementations, the multiple DCIs are received over multiple slots. In one example, a number of layers associated with TPMI over the multiple DCIs is the same as the number of DCIs. In other words, the number of DCI may be equal to the number of layers associated with the TPMI carried by the DCI, e.g., TPMI for three layers may be transmitted by three respective DCI.

The following illustrative example is for an embodiment in which the multiple DCIs are two DCIs received over two slots. In this example, a first DCI of the two DCIs comprises TPMI associated with the first subset of the set of the frequency resources, received over a first of the two slots. A second DCI of the two DCIs received over a second of the two slots comprises: 1) TPMI associated with the second subset of the set of the frequency resources, 2) a parameter indicating whether TPMI associated with the first subset of the set of the frequency resources is valid, and 3) up to two linear combination parameters corresponding to the TPMI associated with the first subset of the set of the frequency resources and the TPMI associated with the second subset of the set of the frequency resources. In this example, the second of the two slots is subsequent to the first of the two slots.

In some embodiments, one linear combination parameter of the two linear combination parameters associated with the second DCI is fixed and hence not reported, e.g., the value of the linear combination parameter is 1. In some other embodiments, a linear combination parameter comprises at least one of an amplitude pairing coefficient and a phase pairing coefficient, and the amplitude paring coefficient is no larger than 1. An amplitude coefficient equal to zero may indicate that TPMI associated with the first DCI is not used.

In another illustrative example, a BWP with 8 frequency resources is associated with two subsets of sets of frequency resources indexed 0,1, . . . , 7. In this example, the first subset of the set of the frequency resources comprises frequency resources indexed 0,2,4,6, and the second subset of the set of the frequency resources comprises frequency resources indexed 1,3,5,7. This example may use a rank 1 transmission with precoding vectors v,k for frequency resource k.

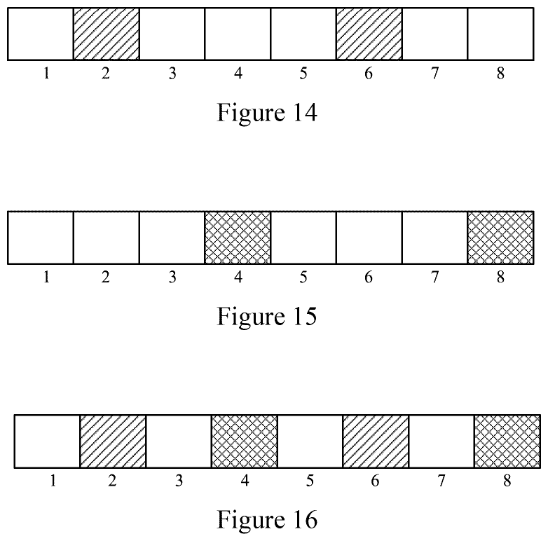

FIGS. 14 to 16 illustrate examples of a BWP comprising eight frequency resources associated with TPMI in accordance with aspects of the present disclosure to help illustrate embodiments of transmitting TPMI for selected frequency resources. In FIG. 14, a first DL signal is received by a UE 104 comprising a first TPMI for frequency resources 2 and 6 in the BWP comprising 8 frequency resources. The first TPMI is received at time slot t. The UE 104 may use extrapolation for precoding over the eight frequency resources using the TPMI for the two frequency resources. The UE 104 receives a second DL signal comprising a second TPMI for frequency resources 4 and 8 of the BWP with eight frequency resources as shown in FIG. 15. The second DL signal is received at time slot t+t₀. Following slot t+t₀, the UE 104 uses extrapolation for precoding over the 8 frequency resources using the TPMI for the four frequency resources shown in FIG. 16, providing better resolution in the frequency domain compared to the TPMI provided at slot t. Accordingly, in some embodiments, TPMI for limited sets of frequency resources may be combined and extrapolated by a UE 104 to provide high resolution precoding within a BWP by aggregating TPMIs received for different frequency resources over different slots.

### UL Codebook Indication

The network may configure a UE 104 with a UL codebook, e.g., a Rel. 18 UL codebook, via a combination of one or more or the following indications represented in the list of implementations discussed below. These implementations may be combined in various embodiments.

In a first implementation, a new value of the higher-layer parameter txConfig in PUSCH-Config Information Element (IE) is introduced. In a first example, the new value is ‘codebook-r18’. An example of the ASN.1 code that corresponds to the latter implementation is provided here for the PUSCH Configuration IE:
txConfig ENUMERATED {codebook, nonCodebook, codebook-r18}
   The original ASN.1 code for this IE can be found in Clause 6.3.2 of 3GPP TS 38.331.

In a second implementation, a new higher-layer parameter, e.g., ‘CodebookType’ that indicates the codebook type, is introduced in the PUSCH-Config IE. In a first example, the new higher-layer parameter may take on one or more values e.g., ‘codebook-r18’, ‘codebook-r15’. In a second example, the new higher-layer parameter is configured if the higher-layer parameter txConfig in PUSCH-Config IE is configured with the value ‘codebook’. An example of the ASN.1 code that corresponds to this implementation is provided here for the PUSCH Configuration IE:
codebookType ENUMERATED {codebook-r15, codebook-r18}OPTIONAL, --Cond codebookBased
   The original ASN.1 code for this IE can be found in Clause 6.3.2 of 3GPP TS 38.331.

In a third implementation, a Rel. 18 UL codebook is inferred from the value of a “Precoding information and number of layers” field (e.g., one or more codepoints of the field) in a DCI scheduling PUSCH transmission, e.g., DCI Format 0_1 or DCI Format 0_2. This value indicates that a Rel. 18 UL codebook is used for the PUSCH transmission and, e.g., a TPMI is provided or otherwise indicated in a subsequent DCI that is transmitted, e.g., over PDCCH, or PDSCH, or indicated in a Medium Access Control-Control Element (MAC-CE) on a PDSCH.

In one example, the value of a “Precoding information and number of layers” field in a DCI scheduling a PUSCH transmission indicates that the TPMI follows the most recent indicated TPMI(s) (e.g., sub-band TPMIs) to the UE 104. The most recent indicated TPMI may be indicated in a DCI that is transmitted, for example, over a PDCCH or PDSCH, or indicated in a MAC-CE on a PDSCH.

In a fourth implementation, a Rel. 18 UL codebook is inferred from the value of a higher-layer parameter usage for an SRS-resourceSet. In one example, the parameter usage set to ‘codebook-r18’.

In a fifth implementation, a Rel. 18 UL codebook is inferred from the association of the codebook configuration with an SRS resource for which the SRS resource comprises eight SRS ports. That is, when an SRS resource has eight SRS ports, the UE 104 automatically implements a Rel. 18 UL codebook.

### Coherence-Based Antenna Grouping

A UE 104 associated with codebook-based precoding of PUSCH layers may signal a set of parameters corresponding to the UE's antenna configuration to a NE 102 based on the UE's capability and/or hardware setup. Several implementations that describe aspects related to the antenna configuration are described below. In some embodiments, one or more elements or features from one or more of the following implementations may be combined.

In a first implementation, a parameter of the set of parameters comprises a total number of antenna ports. In a first example, an antenna port corresponds to an SRS port of at least one SRS resource, wherein each SRS resource of the at least one SRS resource is associated with an SRS resource set. In a second example, the total number of antenna ports is inferred from a maximum number of SRS resources per set. In a third example, the total number of antenna ports is inferred from a maximum number of SRS resources simultaneously transmitted at one symbol.

In a second implementation, a parameter of the set of parameters comprises a decomposition of the SRS ports to two indicators, where a first indicator corresponds to a number of ports in a first dimension, e.g., N₁, and a second indicator corresponds to a number of ports in a second dimension, e.g., N₂. In a first example, the first dimension is a horizontal dimension, and the second dimension is a vertical dimension. In a second example, a product of the number of ports in the first dimension and the number of ports in the second dimension corresponds to the total number of ports in at least one polarization.

In a third implementation, a parameter of the set of parameters corresponds to a number of antenna groups, wherein antenna ports corresponding to each antenna group share a same set of antenna characteristics. In a first example, the number of antenna ports in each antenna group of the antenna groups is the same. In a second example, the antenna ports in each antenna group are fully coherent. In a third example, the antenna ports in each antenna group are associated with a same SRS resource of at least one SRS resource of a set of SRS resources.

In a fourth example, antenna ports in each coherence group are associated with a same SRS resource set. In a fifth example, antennas corresponding to a same antenna group are associated with a uniform spacing in at least one dimension. In a sixth example, antennas corresponding to a same antenna group are associated with a same QCL relationship at least with respect to a spatial relation information. In a seventh example, two antennas corresponding to different antenna groups are associated with a different QCL relationship at least with respect to a spatial relation information.

In a fourth implementation, a parameter of the set of parameters corresponds to a number of antenna ports in each antenna group of a UE 104.

In a fifth implementation, a parameter of the set of parameters corresponds to a number of coherence groups, wherein two antenna ports associated with a same coherence correspond to a first coherence type, and two antenna ports associated with different coherence groups correspond to a second coherence type. In a first example, the number of antenna ports in each coherence group of the coherence groups is the same. In a second example, the first coherence type is a full coherence, and the second coherence type is a partial coherence. In a third example, the first coherence type is a full coherence, and the second coherence type is a non-coherence. In a fourth example, the first coherence type is a partial coherence, and the second coherence type is a non-coherence. In a fifth example, antenna ports in each coherence group are associated with a same SRS resource of at least one SRS resource. In a sixth example, antenna ports in each coherence group are associated with a same SRS resource set.

In a sixth implementation, a parameter of the set of parameters corresponds to a number of antenna ports in each coherence group.

In a seventh implementation, the number of coherence groups is less than or equal to the number of antenna groups. In a first example, the number of antenna groups is an integer multiple of the number of coherence groups, e.g., 4 and 2, respectively. In a second example, each antenna group of the antenna groups is associated with a coherence group. In a third example, coherence groups are identical to antenna groups, and the number of coherence groups is equal to the number of antenna groups. In a fourth example, the number of coherence groups is one, and antennas of all antenna groups are associated with a same coherence type. In a fifth example, a parameter of the set of parameters corresponds to a mapping of the antennas of an antenna group to a coherence group.

In an eighth implementation, a UE 104 is configured with at least one of the following antenna coherence modes: a fully-coherent mode, a non-coherent mode, and a partially coherent mode, wherein the partially coherent mode is further categorized into a plurality of coherence sub-modes based on a number of antenna ports, a number of antenna groups, a number of coherence groups, or a combination thereof. In a first example, for a UE 104 equipped with a total of 8 antenna ports, a first coherence sub-mode of the plurality of coherence sub-modes corresponds to a total number of two coherence groups, and a second coherence sub-mode of the plurality of coherence sub-modes corresponds to a total number of four coherence groups. In a second example, a UE 104 whose total number of antenna ports is equal to the number of coherence groups is configured with a non-coherent mode. In a third example, a UE 104 whose number of coherence groups is one is configured with a fully coherent mode.

In a ninth implementation, the set of parameters are signaled as part of Layer-1 UE features signaling. In a first example, the Layer-1 UE features signaling is associated with at least one codebook-based PUSCH MIMO transmission. In a second example, the Layer-1 UE features signaling is based on Clause 4.1 in 3GPP TR 38.822.

### Structure of UL Codebook

In some embodiments, a UE 104 configured with PUSCH transmission by codebook-based precoding is also configured with a codebook type, and the codebook type is based on a value of at least one parameter of a set of parameters associated with the antenna configuration at the UE 104. Several implementations of different codebook structures and their relationship with a given antenna configuration are described below. In some embodiments, one or more elements or features from one or more of the following implementations may be combined.

In a first implementation, the UE 104 is associated with a selected codebook type of a set of codebook types, wherein the selected codebook type is configured as part of the PUSCH configuration, e.g., by Radio Resource Controller (RRC) signalling.

In a second implementation, the set of codebook types comprises an antenna selection codebook type, wherein an antenna port is selected for a precoding vector corresponding to a PUSCH layer. In one example, for an antenna selection codebook type, a different antenna port is selected for PUSCH layer of a set of PUSCH layers.

In a third implementation, the set of codebook types comprises a codebook type that is based on a Rel-15 UL codebook with transform precoding disabled. In one example, a precoding matrix W corresponding to 8 antenna ports is in a form of an augmentation of two precoding matrices W₁ and W₂, wherein each of W₁ and W₂ correspond to a precoding matrix using four antenna ports with a transform precoding disabled, as shown in FIGS. 3, 6, 7 and 8, such that

$$W = [ \begin{matrix}{W}_{1} & {0}_{1} \\ {0}_{2} & {W}_{2}\end{matrix} ]$$

For instance, W may be a precoding matrix for five-layer transmission using 8 antenna ports, whose matrix size is 8×5, W₁ is a Rel-15 precoding matrix for three-layer transmission using 4 antenna ports with transform precoding disabled, based on one of the precoding matrices in FIG. 7, whose matrix size is a 4×3 corresponding to a first 4 antenna ports of the 8 UE antenna ports of W and a first 3 layers of the 5 layers of W, W₂ is a Rel-15 precoding matrix for two-layer transmission using 4 antenna ports with transform precoding disabled, based on one of the precoding matrices in FIG. 6, whose matrix size is a 4×2 corresponding to a last 4 antenna ports of the 8 UE antenna ports of W and a last 2 layers of the 5 layers of W, and 0₁, 0₂ are all-zero matrices of dimensions 4×2 and 4×3, respectively.

In a fourth implementation, the set of codebook types comprises a DFT-based codebook type. Examples of DFT-based codebook types in this implementation may be the same as or similar to those of the examples of DFT-based codebook types described above with respect to the Structure of TPMI.

In a fifth implementation, the UE 104 is associated with a selected codebook type of a set of codebook types, wherein the selected codebook type is set by a rule based on at least one of an antenna configuration, a number of antenna ports, a number of SRS resource sets associated with the TPMI, a number of SRS resources associated with the TPMI, a number of TPMI, a number of antenna groups, a number of coherence groups, or a combination thereof. In a first example, an antenna configuration with 8 antenna ports and a plurality of antenna groups, wherein a number of antenna ports in each antenna group is two, corresponds to a Rel-15 UL based codebook type with transform precoding disabled. In a second example, an antenna configuration with 8 antenna ports and at least one antenna group, wherein a number of antenna ports in each antenna group is no less than four, corresponds to a DFT-based codebook type. In a third example, an antenna configuration with 8 antenna ports, one coherence group and no more than two antenna groups, corresponds to a DFT-based codebook type. In a fourth example, an antenna configuration with 8 antenna ports, more than two coherence groups, corresponds to a Rel-15 UL based codebook type with transform precoding disabled. In a fifth example, an antenna configuration with 8 antenna ports and 8 coherence groups, corresponds to an antenna selection based codebook type.

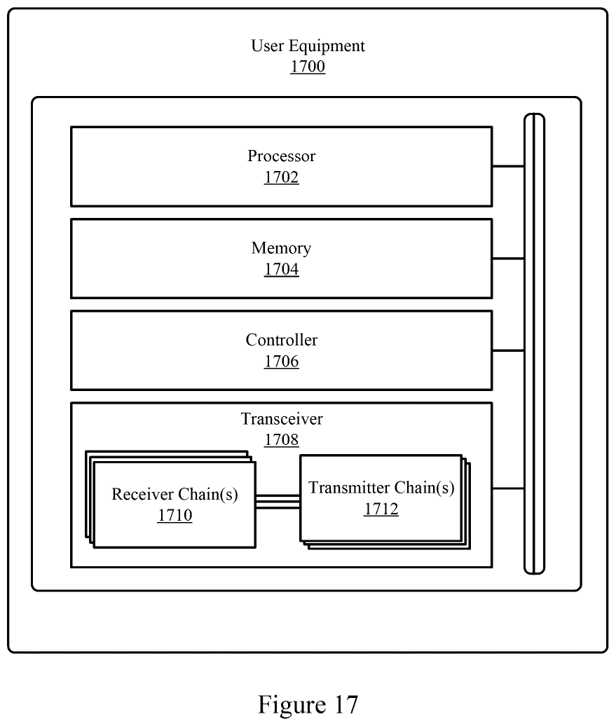

FIG. 17 illustrates an example of a UE 1700 in accordance with aspects of the present disclosure. The UE 1700 may include a processor 1702, a memory 1704, a controller 1706, and a transceiver 1708. The processor 1702, the memory 1704, the controller 1706, or the transceiver 1708, or various combinations thereof or various components thereof may be examples of means for performing various aspects of the present disclosure as described herein. These components may be coupled (e.g., operatively, communicatively, functionally, electronically, electrically) via one or more interfaces.

The processor 1702, the memory 1704, the controller 1706, or the transceiver 1708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1702 may include an intelligent hardware device (e.g., a general-purpose processor, a DSP, a CPU, an ASIC, an FPGA, or any combination thereof). In some implementations, the processor 1702 may be configured to operate the memory 1704. In some other implementations, the memory 1704 may be integrated into the processor 1702. The processor 1702 may be configured to execute computer-readable instructions stored in the memory 1704 to cause the UE 1700 to perform various functions of the present disclosure.

The memory 1704 may include volatile or non-volatile memory. The memory 1704 may store computer-readable, computer-executable code including instructions when executed by the processor 1702 cause the UE 1700 to perform various functions described herein. The code may be stored in a non-transitory computer-readable medium such the memory 1704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1702 and the memory 1704 coupled with the processor 1702 may be configured to cause the UE 1700 to perform one or more of the functions described herein (e.g., executing, by the processor 1702, instructions stored in the memory 1704). For example, the processor 1702 may support wireless communication at the UE 1700 in accordance with examples as disclosed herein. The UE 1700 may be configured to support a means for receiving a configuration signal indicating a precoding scheme for transmitting a sequence of data symbols over a set of antenna ports and a set of frequency resources for uplink (UL) transmissions, and transmitting each symbol in the sequence of symbols from at least two antenna ports of the set of antenna ports, and at least two frequency resources of the set of frequency resources.

The controller 1706 may manage input and output signals for the UE 1700. The controller 1706 may also manage peripherals not integrated into the UE 1700. In some implementations, the controller 1706 may utilize an operating system such as iOS®, ANDROID®, WINDOWS®, or other operating systems. In some implementations, the controller 1706 may be implemented as part of the processor 1702.

In some implementations, the UE 1700 may include at least one transceiver 1708. In some other implementations, the UE 1700 may have more than one transceiver 1708. The transceiver 1708 may represent a wireless transceiver. The transceiver 1708 may include one or more receiver chains 1710, one or more transmitter chains 1712, or a combination thereof.

A receiver chain 1710 may be configured to receive signals (e.g., control information, data, packets) over a wireless medium. For example, the receiver chain 1710 may include one or more antennas for receiving the signal over the air or wireless medium. The receiver chain 1710 may include at least one amplifier (e.g., a low-noise amplifier (LNA)) configured to amplify the received signal. The receiver chain 1710 may include at least one demodulator configured to demodulate the received signal and obtain the transmitted data by reversing the modulation technique applied during transmission of the signal. The receiver chain 1710 may include at least one decoder for decoding the demodulated signal to receive the transmitted data.

A transmitter chain 1712 may be configured to generate and transmit signals (e.g., control information, data, packets). The transmitter chain 1712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1712 may also include at least one power amplifier configured to amplify the modulated signal to an appropriate power level suitable for transmission over the wireless medium. The transmitter chain 1712 may also include one or more antennas for transmitting the amplified signal into the air or wireless medium.

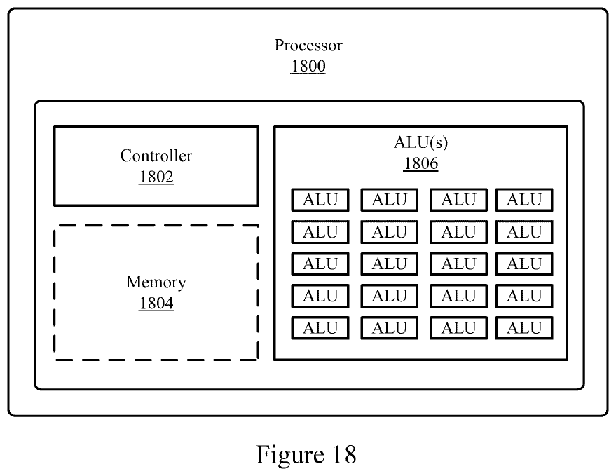

FIG. 18 illustrates an example of a processor 1800 in accordance with aspects of the present disclosure. The processor 1800 may be an example of a processor configured to perform various operations in accordance with examples as described herein. The processor 1800 may include a controller 1802 configured to perform various operations in accordance with examples as described herein. The processor 1800 may optionally include at least one memory 1804, which may be, for example, an L1/L2/L3 cache. Additionally, or alternatively, the processor 1800 may optionally include one or more arithmetic-logic units (ALUs) 1806. One or more of these components may be in electronic communication or otherwise coupled (e.g., operatively, communicatively, functionally, electronically, electrically) via one or more interfaces (e.g., buses).

The processor 1800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1802 may be configured to manage and coordinate various operations (e.g., signaling, receiving, obtaining, retrieving, transmitting, outputting, forwarding, storing, determining, identifying, accessing, writing, reading) of the processor 1800 to cause the processor 1800 to support various operations in accordance with examples as described herein. For example, the controller 1802 may operate as a control unit of the processor 1800, generating control signals that manage the operation of various components of the processor 1800. These control signals include enabling or disabling functional units, selecting data paths, initiating memory access, and coordinating timing of operations.

The controller 1802 may be configured to fetch (e.g., obtain, retrieve, receive) instructions from the memory 1804 and determine subsequent instruction(s) to be executed to cause the processor 1800 to support various operations in accordance with examples as described herein. The controller 1802 may be configured to track memory address of instructions associated with the memory 1804. The controller 1802 may be configured to decode instructions to determine the operation to be performed and the operands involved. For example, the controller 1802 may be configured to interpret the instruction and determine control signals to be output to other components of the processor 1800 to cause the processor 1800 to support various operations in accordance with examples as described herein. Additionally, or alternatively, the controller 1802 may be configured to manage flow of data within the processor 1800. The controller 1802 may be configured to control transfer of data between registers, arithmetic logic units (ALUs), and other functional units of the processor 1800.

The memory 1804 may include one or more caches (e.g., memory local to or included in the processor 1800 or other memory, such RAM, ROM, DRAM, SDRAM, SRAM, MRAM, flash memory, etc. In some implementations, the memory 1804 may reside within or on a processor chipset (e.g., local to the processor 1800). In some other implementations, the memory 1804 may reside external to the processor chipset (e.g., remote to the processor 1800).

The memory 1804 may store computer-readable, computer-executable code including instructions that, when executed by the processor 1800, cause the processor 1800 to perform various functions described herein. The code may be stored in a non-transitory computer-readable medium such as system memory or another type of memory. The controller 1802 and/or the processor 1800 may be configured to execute computer-readable instructions stored in the memory 1804 to cause the processor 1800 to perform various functions. For example, the processor 1800 and/or the controller 1802 may be coupled with or to the memory 1804, the processor 1800, the controller 1802, and the memory 1804 may be configured to perform various functions described herein. In some examples, the processor 1800 may include multiple processors and the memory 1804 may include multiple memories. One or more of the multiple processors may be coupled with one or more of the multiple memories, which may, individually or collectively, be configured to perform various functions herein.

The one or more ALUs 1806 may be configured to support various operations in accordance with examples as described herein. In some implementations, the one or more ALUs 1806 may reside within or on a processor chipset (e.g., the processor 1800). In some other implementations, the one or more ALUs 1806 may reside external to the processor chipset (e.g., the processor 1800). One or more ALUs 1806 may perform one or more computations such as addition, subtraction, multiplication, and division on data. For example, one or more ALUs 1806 may receive input operands and an operation code, which determines an operation to be executed. One or more ALUs 1806 be configured with a variety of logical and arithmetic circuits, including adders, subtractors, shifters, and logic gates, to process and manipulate the data according to the operation. Additionally, or alternatively, the one or more ALUs 1806 may support logical operations such as AND, OR, exclusive-OR (XOR), not-OR (NOR), and not-AND (NAND), enabling the one or more ALUs 1806 to handle conditional operations, comparisons, and bitwise operations.

The processor 1800 may support wireless communication in accordance with examples as disclosed herein. The processor 1800 may be configured to or operable to support a means for receiving a configuration signal indicating a precoding scheme for transmitting a sequence of data symbols over a set of antenna ports and a set of frequency resources for UL transmissions, and transmitting each symbol in the sequence of symbols from at least two antenna ports of the set of antenna ports, and at least two frequency resources of the set of frequency resources.

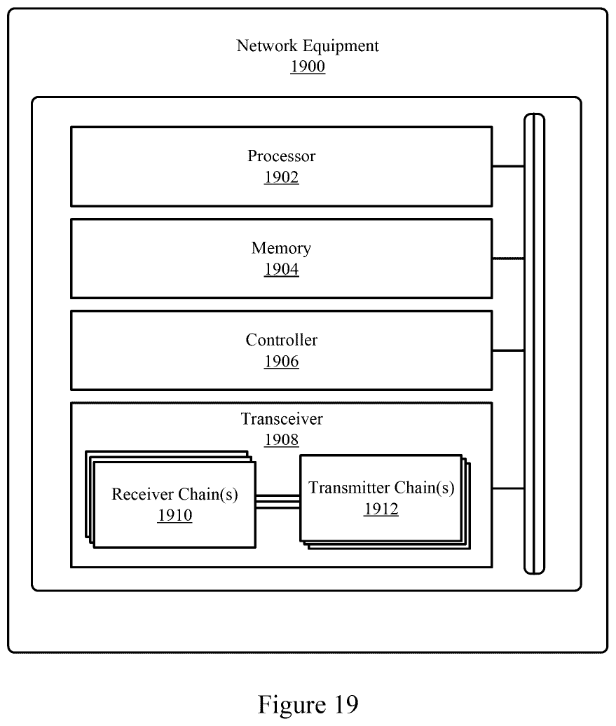

FIG. 19 illustrates an example of a NE 1900 in accordance with aspects of the present disclosure. The NE 1900 may include a processor 1902, a memory 1904, a controller 1906, and a transceiver 1908. The processor 1902, the memory 1904, the controller 1906, or the transceiver 1908, or various combinations thereof or various components thereof may be examples of means for performing various aspects of the present disclosure as described herein. These components may be coupled (e.g., operatively, communicatively, functionally, electronically, electrically) via one or more interfaces.

The processor 1902, the memory 1904, the controller 1906, or the transceiver 1908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1902 may include an intelligent hardware device (e.g., a general-purpose processor, a DSP, a CPU, an ASIC, an FPGA, or any combination thereof). In some implementations, the processor 1902 may be configured to operate the memory 1904. In some other implementations, the memory 1904 may be integrated into the processor 1902. The processor 1902 may be configured to execute computer-readable instructions stored in the memory 1904 to cause the NE 1900 to perform various functions of the present disclosure.

The memory 1904 may include volatile or non-volatile memory. The memory 1904 may store computer-readable, computer-executable code including instructions when executed by the processor 1902 cause the NE 1900 to perform various functions described herein. The code may be stored in a non-transitory computer-readable medium such the memory 1904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1902 and the memory 1904 coupled with the processor 1902 may be configured to cause the NE 1900 to perform one or more of the functions described herein (e.g., executing, by the processor 1902, instructions stored in the memory 1904). For example, the processor 1902 may support wireless communication at the NE 1900 in accordance with examples as disclosed herein. The NE 1900 may be configured to support a means for receiving a configuration signal indicating a precoding scheme for transmitting a sequence of data symbols over a set of antenna ports and a set of frequency resources for UL transmissions, and transmitting each symbol in the sequence of symbols from at least two antenna ports of the set of antenna ports, and at least two frequency resources of the set of frequency resources.

The controller 1906 may manage input and output signals for the NE 1900. The controller 1906 may also manage peripherals not integrated into the NE 1900. In some implementations, the controller 1906 may utilize an operating system such as iOS®, ANDROID®, WINDOWS®, or other operating systems. In some implementations, the controller 1906 may be implemented as part of the processor 1902.

In some implementations, the NE 1900 may include at least one transceiver 1908. In some other implementations, the NE 1900 may have more than one transceiver 1908. The transceiver 1908 may represent a wireless transceiver. The transceiver 1908 may include one or more receiver chains 1910, one or more transmitter chains 1912, or a combination thereof.

A receiver chain 1910 may be configured to receive signals (e.g., control information, data, packets) over a wireless medium. For example, the receiver chain 1910 may include one or more antennas for receiving the signal over the air or a wireless medium. The receiver chain 1910 may include at least one amplifier (e.g., a low-noise amplifier (LNA)) configured to amplify the received signal. The receiver chain 1910 may include at least one demodulator configured to demodulate the received signal and obtain the transmitted data by reversing the modulation technique applied during transmission of the signal. The receiver chain 1910 may include at least one decoder for decoding the demodulated signal to receive the transmitted data.

A transmitter chain 1912 may be configured to generate and transmit signals (e.g., control information, data, packets). The transmitter chain 1912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1912 may also include at least one power amplifier configured to amplify the modulated signal to an appropriate power level suitable for transmission over the wireless medium. The transmitter chain 1912 may also include one or more antennas for transmitting the amplified signal into the air or wireless medium.

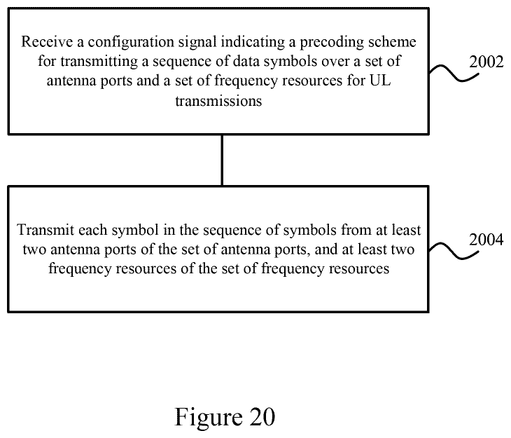

FIG. 20 illustrates a flowchart of a method in accordance with aspects of the present disclosure. The operations of the method may be implemented by a UE as described herein. In some implementations, the UE may execute a set of instructions to control the function elements of the UE to perform the described functions.

At 2002, the method may include receiving a configuration signal indicating a precoding scheme for transmitting a sequence of data symbols over a set of antenna ports and a set of frequency resources for UL transmissions. The operations of 2002 may be performed in accordance with examples as described herein. In some implementations, aspects of the operations of 2002 may be performed by a UE as described with reference to FIG. 17.

At 2004, the method may include transmitting each symbol in the sequence of symbols from at least two antenna ports of the set of antenna ports, and at least two frequency resources of the set of frequency resources. Transmitting each symbol in the sequence of symbols may include transmitting a first symbol using a first port of the at least two antenna ports and a first frequency resource of the at least two frequency resources, and transmitting a transformed function of the first symbol using a second port of the at least two antenna ports and a second frequency resource of the at least two frequency resources. The operations of 2004 may be performed in accordance with examples as described herein. In some implementations, aspects of the operations of 2004 may be performed by a UE as described with reference to FIG. 17.

It should be noted that the method described herein describes a possible implementation, and that the operations and the steps may be rearranged or otherwise modified and that other implementations are possible.

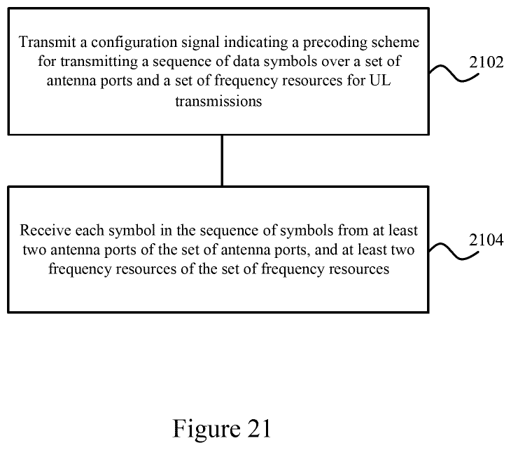

FIG. 21 illustrates a flowchart of a method in accordance with aspects of the present disclosure. The operations of the method may be implemented by a NE as described herein. In some implementations, the NE may execute a set of instructions to control the function elements of the NE to perform the described functions.

At 2102, the method may include transmitting a configuration signal indicating a precoding scheme for transmitting a sequence of data symbols over a set of antenna ports and a set of frequency resources for UL transmissions. The operations of 2102 may be performed in accordance with examples as described herein. In some implementations, aspects of the operations of 2102 may be performed by a NE as described with reference to FIG. 19.

At 2104, the method may include receiving each symbol in the sequence of symbols from at least two antenna ports of the set of antenna ports, and at least two frequency resources of the set of frequency resources. The operations of 2104 may be performed in accordance with examples as described herein. In some implementations, aspects of the operations of 2104 may be performed by a NE as described with reference to FIG. 19.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A UE for wireless communication, comprising:
at least one memory; and
at least one processor coupled with the at least one memory and configured to cause the UE to:
receive a configuration signal indicating a precoding scheme for transmitting a sequence of data symbols over a set of antenna ports and a set of frequency resources for uplink (UL) transmissions; and
transmit each symbol in the sequence of symbols from at least two antenna ports of the set of antenna ports, and at least two frequency resources of the set of frequency resources, wherein transmitting each symbol in the sequence of symbols includes:
transmitting a first symbol using a first port of the at least two antenna ports and a first frequency resource of the at least two frequency resources; and
transmitting a transformed function of the first symbol using a second port of the at least two antenna ports and a second frequency resource of the at least two frequency resources.

2. The UE of claim 1 wherein the precoding scheme is an open-loop precoding scheme comprising a Space-Frequency Block Coding (SFBC) scheme.

3. The UE of claim 1, wherein the configuration signal indicates a set of Sounding Reference Signals (SRSs) associated with the UL transmissions.

4. The UE of claim 3, wherein the at least one processor is further configured to cause the UE to:
apply at least one of a modulation order and a channel code rate to the sequence of data symbols based on the set of SRSs.

5. The UE of claim 3, wherein the at least one processor is further configured to cause the UE to:
select a comb structure of the set of SRSs based on a size of the set of antenna ports.

6. The UE of claim 5, wherein an index offset value associated with the comb structure of the set of SRS changes across time slots carrying the set of SRSs.

7. The UE of claim 1, wherein at least a portion of the sequence of symbols have complex values, and the transformed function of the first symbol is a conjugate transposition transformation.

8. The UE of claim 1, wherein transmitting each symbol in the sequence of symbols further includes:
transmitting a second symbol using the first port and the second frequency resource; and
transmitting a transformed function of the second symbol using the second port and the first frequency resource, wherein the transformed function of the second symbol is the same transformed function as the transformed function of the first symbol except for a phase offset.

9. The UE of claim 8, wherein the sequence of symbols is transmitted over a Physical Uplink Control Channel (PUCCH) or a Physical Uplink Shared Channel (PUSCH), and the first symbol and the second symbol are associated with a same transmission layer.

10. The UE of claim 9, wherein the sequence of symbols is transmitted over the PUSCH, and the first symbol and the second symbol are associated with first transmission layer and a second transmission layer of an UL codeword transmission, respectively.

11. The UE of claim 1, wherein the at least two frequency resources correspond to at least two sub-carriers, at least two groups of sub-carriers, at least two Resource Blocks (RBs), or at least two groups of RBs.

12. The UE of claim 1, wherein a number of ports of a Demodulation Reference Signal (DMRS) associated with a PUSCH transmission from the UE is equal to a number of antenna ports in the at least two antenna ports, and wherein the DMRS from the at least two antenna ports are orthogonally multiplexed in at least one of time, frequency, and code domains.

13. The UE of claim 12, wherein each DMRS port of the DMRS ports is Quasi-Co-Located with a respective SRS port, and
wherein a mapping of the DMRS ports and SRS ports is based on identifier values of the DMRS ports, identifier values of the SRS ports, or both.

14. The UE of claim 13, wherein the quasi-colocation is with respect to average delay, delay spread, Doppler shift, Doppler spread, average gain, spatial parameter, or a combination thereof.

15. A method performed by a User Equipment (UE), the method comprising:
receiving a configuration signal indicating a precoding scheme for transmitting a sequence of data symbols over a set of antenna ports and a set of frequency resources for uplink (UL) transmissions; and
transmitting each symbol in the sequence of symbols from at least two antenna ports of the set of antenna ports, and at least two frequency resources of the set of frequency resources, wherein transmitting each symbol in the sequence of symbols includes:
transmitting a first symbol using a first port of the at least two antenna ports and a first frequency resource of the at least two frequency resources; and
transmitting a transformed function of the first symbol using a second port of the at least two antenna ports and a second frequency resource of the at least two frequency resources.

16. The method of claim 15, wherein transmitting each symbol in the sequence of symbols further includes:
transmitting a second symbol using the first port and the second frequency resource; and
transmitting a transformed function of the second symbol using the second port and the first frequency resource, wherein the transformed function of the second symbol is the same transformed function as the transformed function of the first symbol except for a phase offset.

17. The method of claim 16, wherein a number of ports of a Demodulation Reference Signal (DMRS) associated with a PUSCH transmission from the UE is equal to a number of antenna ports in the at least two antenna ports, and wherein the DMRS from the at least two antenna ports are orthogonally multiplexed in at least one of time, frequency, and code domains.

18. A base station for wireless communication, comprising:
at least one memory; and
at least one processor coupled with the at least one memory and configured to cause the base station to:
transmit a configuration signal indicating a precoding scheme for transmitting a sequence of data symbols over a set of antenna ports and a set of frequency resources for uplink (UL) transmissions; and
receive each symbol in the sequence of symbols from at least two antenna ports of the set of antenna ports, and at least two frequency resources of the set of frequency resources, wherein transmitting each symbol in the sequence of symbols includes:
receiving a first symbol using a first port of the at least two antenna ports and a first frequency resource of the at least two frequency resources; and
receiving a transformed function of the first symbol using a second port of the at least two antenna ports and a second frequency resource of the at least two frequency resources.

19. The base station of claim 18, wherein receiving each symbol in the sequence of symbols further includes:
receiving a second symbol using the first port and the second frequency resource; and
receiving a transformed function of the second symbol using the second port and the first frequency resource, wherein the transformed function of the second symbol is the same transformed function as the transformed function of the first symbol.

20. The base station of claim 18, wherein a number of ports of a Demodulation Reference Signal (DMRS) associated with a PUSCH transmission from a UE to which the configuration signal is transmitted is equal to a number of antenna ports in the at least two antenna ports, and wherein the DMRS from the at least two antenna ports are orthogonally multiplexed in at least one of time, frequency, and code domains.
